(19) United States
(12) Patent Application Publication
(10) Pub. No.: US 2018/0050433 A1
(43) Pub. Date: Feb. 22, 2018

(54) MACHINE TOOL

(71) Applicant: TOSHIBA KIKAI KABUSHIKI KAISHA, TOKYO-TO (JP)

(72) Inventors: KATSUMI HIRABAYASHI, SHIZUOKA-KEN (JP); ATSUSHI TADA, SHIZUOKA-KEN (JP)

(73) Assignee: TOSHIBA KIKAI KABUSHIKI KAISHA, TOKYO-TO (JP)

(21) Appl. No.: 15/558,414

(22) PCT Filed: Mar. 9, 2016
(86) PCT No.: PCT/JP2016/057341

§ 371 Date: Sep. 14, 2017

(30) Foreign Application Priority Data
Mar. 17, 2015 (JP) 2015-053811

(51) Int. Cl. B23Q 17/22; B23Q 5/04

(52) U.S. Cl. CPC B23Q 17/2233; B23Q 15/18; B23Q 5/04

(57) ABSTRACT

A machine tool of the present embodiment includes: a column that is disposed in a vertically standing manner and has a predetermined linear expansion coefficient; a spindle head that is supported by the column and supports a horizontal spindle for attaching a tool thereto; and a reference bar that is disposed separately from the column and has a linear expansion coefficient that is different from the linear expansion coefficient of the column wherein the column has a column-side measurement target zone, the reference bar has a reference bar-side measurement target zone, and a measurement means measures a distance between the column-side measurement target zone and the reference bar-side measurement target zone.

### TECHNICAL FIELD

The present invention relates to a machine tool in which a spindle head is supported by a column, and particularly to a machine tool in which a spindle is supported in a vertically standing manner by a column disposed on a foundation or to a machine tool in which a spindle is horizontally supported by the column such as a horizontal boring machine.

### BACKGROUND ART

Machine tools in which a spindle head is supported by a column are conventionally known. Machine tools of this type are classified into a movable column type having a column movable on a bed or a foundation and a fixed column type having a column that does not move on a bed or a foundation (workpiece moves).

In either machine tool, it is required to control a position of a tip of a spindle (spindle tip) attached to a spindle head with a high accuracy in order to precisely process a workpiece. Depending on the environment of a place where the machine tool is installed, however, a difference in temperature (temperature gradient) is generated in a column and the column is deformed by heat due to a difference in room temperature in the front, the back, the right, and the left of the column, an air flow from an air conditioner or a window (outdoors), the manner the sunlight is reflected on the column, or other reasons. There are cases where a position of the spindle tip is undesirably displaced as a result of this. The weight of a tool (attachment) attached to the spindle tip for processing a workpiece varies and thus the weight supported by the column varies according to a tool attached thereto. There are cases where a deflection amount of the column varies due to this and a position of the spindle tip is undesirably displaced as a result of this.

There is also another disadvantage that the spindle tip is displaced by heat from a desired position due to heat generated in a rotation driving unit of the spindle head that rotates the spindle. Specifically, (1) due to a temperature rise in the spindle head that rotates the spindle, the spindle head itself including the spindle is deformed over time by thermal expansion, and (2) due to the heat conducted from the spindle head, the column supporting the spindle head is also deformed over time by thermal expansion. As a result of these, the spindle tip is undesirably displaced and thus there is a disadvantage that a processing accuracy is degraded in processing of a workpiece by a tool attached to the spindle tip.

As for displacement of the spindle head including the spindle, in consideration to that displacement attributable to thermal expansion of the spindle head is dominant in the spindle direction (referred to as a Z axis direction), conventionally employed are methods to measure the temperature near the spindle head that is the heat source, to estimate elongation in the spindle direction from the temperature, and to perform correction or methods to estimate elongation in the spindle direction based on the number of revolutions or previous measurement values of the spindle and to perform correction. These are called Z axis thermal displacement correction.

JP 57-48448 A (Patent Literature 1) discloses a method to dispose a reference bar (quartz glass rod) provided with a magnetizer at one end portion thereof along a surface of a spindle head and to fix the other end portion of the reference bar to the spindle head, to measure a distance between a position of the magnetizer and a position of a magnetic detection head fixed on the surface of the spindle head associated with the magnetizer, and to correct thermal displacement of the spindle tip in a spindle direction based on the measurement result.

By the method of Patent Literature 1, however, although thermal displacement of the spindle tip in the spindle direction is corrected, thermal displacement in the vertical direction is not corrected. In order to deal with this disadvantage, JP 7-115282 B (Patent Literature 2) discloses a method to dispose a plurality of reference bars provided with a magnetizer at one end portion thereof along a surface of a spindle head and to fix the other end portions of the plurality of reference bars to the spindle head, to measure distances between positions of the respective magnetizers and positions of respective detection heads fixed on the surface of the spindle head associated with the magnetizers, and to correct thermal displacement of the spindle head not only in the spindle direction but also in the vertical direction based on these measurement results.

### CITATION LIST

### Patent Literature

Patent Literature 1: JP 57-48448 A

Patent Literature 2: JP 7-115282 B

When thermal displacement of the spindle head is corrected according to Patent Literature 2, however, there are cases where displacement still remains in directions (X axis direction and Y axis direction) perpendicular to the spindle direction (Z axis direction) especially in a machine tool where the spindle direction is horizontal, such as a boring machine.

Such displacement in the X axis direction and the Y axis direction may be attributable to the environment of a place where the machine tool is installed, variations in the weight supported by a column, or other reasons as described above. However, correction of displacement of a spindle tip attributable to deformation (posture change) of a column is not conventionally examined or implemented.

In consideration to the above issues, an object of the present invention is to provide a machine tool capable of measuring a posture change of a column at a low cost with a high accuracy, thereby correcting displacement of a spindle tip attributable to the posture change, and implementing precise processing of a workpiece.

### DISCLOSURE OF THE INVENTION

The present invention includes a machine tool including: a column that is disposed in a vertically standing manner and has a predetermined linear expansion coefficient; a spindle head that is supported by the column and supports a horizontal spindle for attaching a tool thereto; and a reference bar that is disposed separately from the column and has a linear expansion coefficient that is different from the linear expansion coefficient of the column. The column has a column-side measurement target zone, the reference bar has a reference bar-side measurement target zone, and a measurement means measures a distance between the column-side measurement target zone and the reference bar-side measurement target zone.

According to the present invention, directly measuring the distance between the reference bar-side measurement target zone and the column-side measurement target zone by the measurement means allows for measuring thermal deformation of the column at a low cost with a high accuracy. This allows for measuring a posture change of the column at a low cost with a high accuracy, thereby allowing for providing the machine tool capable of correcting displacement of the spindle tip attributable to the posture change and implementing precise processing of a workpiece.

That is, a machine tool according to the present invention preferably further includes: a posture change evaluation unit that evaluates a posture change of the spindle head based on each of the measurement results of the distance by the measurement means; and a control unit that controls a position of a tip of the spindle based on the evaluation result by the posture change evaluation unit.

Preferably, the posture change evaluation unit stores a predetermined reference distance between the reference bar-side measurement target zone and the column-side measurement target zone in each of a vertical direction and two directions perpendicular to each other on a horizontal plane, and the posture change evaluation unit evaluates an posture change of the spindle head by comparing the reference distance and the distance measured by the measurement means.

Alternatively preferably, the measurement means measures, as a reference distance, a distance between the reference bar-side measurement target zone and the column-side measurement target zone in each of a vertical direction and the two directions perpendicular to each other on the horizontal plane under a predetermined reference condition, and the posture change evaluation unit evaluates a posture change of the spindle head by comparing the reference distance and the distance measured by the measurement means.

Alternatively preferably, the measurement means sequentially measures a distance between the reference bar-side measurement target zone and the column-side measurement target zone in each of a vertical direction and the two directions perpendicular to each other on the horizontal plane, and the posture change evaluation unit sequentially evaluates a posture change of the spindle head by sequentially comparing the distances measured by the measurement means.

Preferably, a first column-side measurement target zone and a second column-side measurement target zone, apart from each other by a predetermined distance, on a top surface of the column are associated with the reference bar-side measurement target zone, the two directions perpendicular to each other on a horizontal plane are an axial direction of the spindle and a direction perpendicular to the axial direction of the spindle on the horizontal plane, the measurement means measures a distance between the reference bar-side measurement target zone and the first column-side measurement target zone in each of the vertical direction, the axial direction of the spindle, and the direction perpendicular to the axial direction of the spindle on the horizontal plane and a distance between the reference bar-side measurement target zone and the second column-side measurement target zone in each of the vertical direction and the direction perpendicular to the axial direction of the spindle on a horizontal plane, and the posture change evaluation unit evaluates a posture change of the spindle head by evaluating inclination of a linear line connecting the first column measurement target zone and the second column-side measurement target zone based on the measurement results of the distances by the measurement means.

In this case, a calculation process is simple and thus a posture change of the column can be promptly evaluated.

Preferably, the posture change evaluation unit stores a predetermined reference distance for each of a distance between the reference bar-side measurement target zone and the first column-side measurement target zone in each of the vertical direction, the axial direction of the spindle, and the direction perpendicular to the axial direction of the spindle on the horizontal plane and a distance between the reference bar-side measurement target zone and the second column-side measurement target zone in each of the vertical direction and the direction perpendicular to the axial direction of the spindle on the horizontal plane, and the posture change evaluation unit evaluates a posture change of the spindle head by comparing the reference distance and the distance measured by the measurement means.

Alternatively preferably, the measurement means measures, as a reference distance, a distance between the reference bar-side measurement target zone and the first column-side measurement target zone in each of the vertical direction, the axial direction of the spindle, and the direction perpendicular to the axial direction of the spindle on the horizontal plane and a distance between the reference bar-side measurement target zone and the second column-side measurement target zone in each of the vertical direction and the direction perpendicular to the axial direction of the spindle on the horizontal plane under a predetermined reference condition, and the posture change evaluation unit evaluates a posture change of the spindle head by comparing the reference distance and the distance measured by the measurement means.

Alternatively preferably, the measurement means sequentially measures a distance between the reference bar-side measurement target zone and the first column-side measurement target zone in each of the vertical direction, the axial direction of the spindle, and the direction perpendicular to the axial direction of the spindle on the horizontal plane and a distance between the reference bar-side measurement target zone and the second column-side measurement target zone in each of the vertical direction and the direction perpendicular to the axial direction of the spindle on the horizontal plane, and the posture change evaluation unit sequentially evaluates a posture change of the spindle head by sequentially comparing the distances measured by the measurement means.

Preferably, the reference bar has a linear expansion coefficient of 1.0×10⁻⁶/° C. or less at 30° C. to 100° C.

In this case, thermal displacement rarely occurs in the reference bar and thus the distance between the measurement target zone of the reference bar and the measurement target zone of the column can be handled as thermal displacement in the measurement target zone of the column.

Preferably, the measurement means is a displacement sensor of a contact type supported at the column-side measurement target zone. Alternatively, the measurement means may be a displacement sensor of a contactless type supported at the column-side measurement target zone.

The plurality of reference bars may be included. In this case, when a plurality of column-side measurement target zones is set, associating one reference bar with each of the column-side measurement target zones allows for measuring with a higher accuracy a distance between the column-side measurement target zone and the reference bar-side measurement target zone associated therewith.

A pair of columns may be included and the reference bar may be provided associated with each of the paired columns. In this case, even in a machine tool having two columns such as a double column type machining center, displacement of a spindle tip attributable to a posture change in the column can be corrected, thereby implementing precise processing of a workpiece.

The present invention also includes a machine tool including: a spindle head that supports a spindle for attaching a tool thereto; a column that is disposed in a vertically standing manner, has a predetermined linear expansion coefficient in the vertical direction, and supports the spindle head; a reference bar that has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column, and a measurement target zone on the other end of which is possibly displaced relative to the column. In the column, a measurement target zone is associated with the measurement target zone of the reference bar, and a measurement means measures a distance between the measurement target zone of the reference bar and the measurement target zone of the column in the vertical direction.

According to the present invention, directly measuring the distance in the vertical direction between the measurement target zone of the column and the measurement target zone of the reference bar by the measurement means based on a difference in linear expansion coefficients in the vertical direction of the column and the reference bar allows for measuring thermal displacement of the column at a low cost with a high accuracy. This allows for measuring a posture change of the column at a low cost with a high accuracy, thereby allowing for providing the machine tool capable of correcting displacement of the spindle tip attributable to the posture change and implementing precise processing of the workpiece.

That is, a machine tool according to the present invention preferably further includes: a posture change evaluation unit that evaluates a posture change of the column based on the measurement result of the distance in the vertical direction by the measurement means; and a control unit that controls a position of a tip of the spindle based on the evaluation result by the posture change evaluation unit.

Preferably, two measurement target zones apart from each other by a predetermined distance on a top surface of the column are associated with the measurement target zones of the reference bars, the measurement means measures distances in the vertical direction between the measurement target zones of the reference bars and the two measurement target zones of the column, and the posture change evaluation unit evaluates a posture change of the column by evaluating a change in inclination of a linear line connecting the two measurement target zones of the column based on the measurement results of the two distances in the vertical direction by the measurement means.

In this case, employing a simple calculation process of evaluating a change in inclination of the linear line allows for promptly evaluating a posture change of the column.

Alternatively preferably, three measurement target zones apart from each other by a predetermined distance on a top surface of the column are associated with the measurement target zones of the reference bars, the measurement means measures distances in the vertical direction between the measurement target zones of the reference bars and the three measurement target zones of the column, and the posture change evaluation unit evaluates a posture change of the column, for example by evaluating a change in inclination of a plane defined by the three measurement target zones of the column based on the measurement results of the three distances in the vertical direction by the measurement means.

In this case, a posture change of the column can be accurately evaluated and thus displacement of the spindle tip can be corrected with a higher accuracy.

Alternatively preferably, four measurement target zones apart from each other by a predetermined distance on a top surface of the column are associated with the measurement target zones of the reference bars, the measurement means measures distances in the vertical direction between the measurement target zones of the reference bars and the four measurement target zones of the column, and the posture change evaluation unit evaluates a posture change of the column based on the measurement results of the four distances in the vertical direction by the measurement means.

In this case, a posture change of the column can be more accurately evaluated and thus displacement of the spindle tip can be corrected with an even higher accuracy.

Preferably, the posture change evaluation unit stores a predetermined reference distance, and the posture change evaluation unit evaluates a posture change of the column by comparing the reference distance and the distance in the vertical direction measured by the measurement means.

Alternatively preferably, the measurement means measures, as a reference distance, a distance in the vertical direction between the measurement target zone of the reference bar and the measurement target zone of the column under a predetermined reference condition, and the posture change evaluation unit evaluates a posture change of the column by comparing the reference distance and the distance in the vertical direction measured by the measurement means.

Alternatively preferably, the measurement means sequentially measures a distance in the vertical direction between the measurement target zone of the reference bar and the measurement target zone of the column, and the posture change evaluation unit sequentially evaluates a posture change of the column by sequentially comparing the distances in the vertical direction measured by the measurement means.

Preferably, the reference bar has a linear expansion coefficient in the vertical direction of 1.0×10⁻⁶/° C. or less at 30° C. to 100° C.

In this case, thermal displacement in the vertical direction rarely occurs in the reference bar and thus the distance in the vertical direction between the measurement target zone of the reference bar and the measurement target zone of the column can be handled as thermal displacement in the vertical direction in the measurement target zone of the column.

Preferably, the column is formed with a through hole extending in the vertical direction and the reference bar is supported by a bearing provided to the through hole. In this case, the reference bar can be easily disposed in such a manner not interfering with elongation or shrinkage of the column in the vertical direction.

Further preferably, the measurement means is a displacement sensor of a contact type supported at the measurement target zone of the column. Alternatively, the measurement means may be a displacement sensor of a contactless type supported at the measurement target zone of the column.

Alternatively, the measurement means may be a displacement sensor of a contact type supported at the measurement target zone of the reference bar. Alternatively, the measurement means may be a displacement sensor of a contactless type supported at the measurement target zone of the reference bar.

The present invention includes a machine tool having a plurality of reference bars associated with a plurality of measurement target zones of a column. That is, the present invention also includes a machine tool including: a spindle head that supports a spindle for attaching a tool thereto; a column that is disposed in a vertically standing manner, has a predetermined linear expansion coefficient in the vertical direction, and supports the spindle head; and a first reference bar and a second reference bar, each of which has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column and a measurement target zone on the other end of which is possibly displaced relative to the column. In the column, a first measurement target zone is associated with the measurement target zone of the first reference bar, in the column, a second measurement target zone is associated with the measurement target zone of the second reference bar, a first measurement means measures a distance in the vertical direction between the measurement target zone of the first reference bar and the first measurement target zone of the column, and a second measurement means measures a distance in the vertical direction between the measurement target zone of the second reference bar and the second measurement target zone of the column.

According to the present invention, directly measuring the distance in the vertical direction between the first measurement target zone and the second measurement target zone of the column and the measurement target zones of the first reference bar and the second reference bar, respectively, by the measurement means based on differences in linear expansion coefficients in the vertical direction of the column and the first reference bar and the second reference bar allows for measuring thermal displacement of the column at a low cost with an even higher accuracy. This allows for measuring a posture change of the column at a low cost with an even higher accuracy, thereby allowing for providing the machine tool capable of correcting displacement of the spindle tip attributable to the posture change and implementing precise processing of the workpiece.

The present invention also includes a machine tool including: a spindle head that supports a spindle for attaching a tool thereto; a column that is disposed in a vertically standing manner, has a predetermined linear expansion coefficient in the vertical direction, and supports the spindle head; and a first reference bar, a second reference bar, and a third reference bar, each of which has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column and a measurement target zone on the other end of which is possibly displaced relative to the column. In the column, a first measurement target zone is associated with the measurement target zone of the first reference bar, in the column, a second measurement target zone is associated with the measurement target zone of the second reference bar, in the column, a third measurement target zone is associated with the measurement target zone of the third reference bar, a first measurement means measures a distance in the vertical direction between the measurement target zone of the first reference bar and the first measurement target zone of the column, a second measurement means measures a distance in the vertical direction between the measurement target zone of the second reference bar and the second measurement target zone of the column, and a third measurement means measures a distance in the vertical direction between the measurement target zone of the third reference bar and the third measurement target zone of the column.

According to the present invention, directly measuring the distance in the vertical direction between the first measurement target zone, the second measurement target zone, and the third measurement target zone of the column and the measurement target zones of the first reference bar, the second reference bar, and the third reference bar, respectively, by the measurement means based on differences in linear expansion coefficients in the vertical direction of the column and the first reference bar, the second reference bar, and the third reference bar allows for measuring thermal displacement of the column at a low cost with an even higher accuracy. This allows for measuring a posture change of the column at a low cost with an even higher accuracy, thereby allowing for providing the machine tool capable of correcting displacement of the spindle tip attributable to the posture change and implementing precise processing of the workpiece.

The present invention also includes a machine tool including: a spindle head that supports a spindle for attaching a tool thereto; a column that is disposed in a vertically standing manner, has a predetermined linear expansion coefficient in the vertical direction, and supports the spindle head; and a first reference bar, a second reference bar, a third reference bar, and a fourth reference bar, each of which has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column and a measurement target zone on the other end of which is possibly displaced relative to the column. In the column, a first measurement target zone is associated with the measurement target zone of the first reference bar, in the column, a second measurement target zone is associated with the measurement target zone of the second reference bar, in the column, a third measurement target zone is associated with the measurement target zone of the third reference bar, in the column, a fourth measurement target zone is associated with the measurement target zone of the fourth reference bar, a first measurement means measures a distance in the vertical direction between the measurement target zone of the first reference bar and the first measurement target zone of the column, a second measurement means measures a distance in the vertical direction between the measurement target zone of the second reference bar and the second measurement target zone of the column, a third measurement means measures a distance in the vertical direction between the measurement target zone of the third reference bar and the third measurement target zone of the column, and a fourth measurement means measures a distance in the vertical direction between the measurement target zone of the fourth reference bar and the fourth measurement target zone of the column.

According to the present invention, directly measuring the distance in the vertical direction between the first measurement target zone, the second measurement target zone, the third measurement target zone, and the fourth measurement target zone of the column and the measurement target zones of the first reference bar, the second reference bar, the third reference bar, and the fourth reference bar, respectively, by the measurement means based on differences in linear expansion coefficients in the vertical direction of the column and the first reference bar, the second reference bar, the third reference bar, and the fourth reference bar allows for measuring thermal displacement of the column at a low cost with an even higher accuracy. This allows for measuring a posture change of the column at a low cost with an even higher accuracy, thereby allowing for providing the machine tool capable of correcting displacement of the spindle tip attributable to the posture change and implementing precise processing of the workpiece.

The present invention is alternatively a machine tool including: a column that is disposed in a vertically standing manner and has a predetermined linear expansion coefficient; a spindle head that is supported by the column and supports a vertical spindle for attaching a tool thereto; and a reference bar that is disposed separately from the column and has a linear expansion coefficient that is different from the linear expansion coefficient of the column. The column has a column-side measurement target zone, the reference bar has a reference bar-side measurement target zone, and a measurement means measures a distance between the column-side measurement target zone and the reference bar-side measurement target zone.

According to the present invention, directly measuring the distance between the reference bar-side measurement target zone and the column-side measurement target zone by the measurement means allows for measuring thermal deformation of the column at a low cost with a high accuracy. This allows for measuring a posture change of the column at a low cost with a high accuracy, thereby allowing for providing the machine tool capable of correcting displacement of the spindle tip attributable to the posture change and implementing precise processing of a workpiece.

Examples include a machine tool wherein the reference bar includes a first reference bar and a second reference bar, the first reference bar includes a first reference bar-side measurement target zone, and the second reference bar includes a second reference bar-side measurement target zone, the column includes a first column and a second column, the first column includes a first column-side measurement target zone, and the second column includes a second column-side measurement target zone, the measurement means includes a first measurement means and a second measurement means, the first reference bar-side measurement target zone, the first column-side measurement target zone, and the first measurement means are associated with each other, and the second reference bar-side measurement target zone, the second column-side measurement target zone, and the second measurement means are associated with each other.

Preferably, the machine tool as described above further includes: a posture change evaluation unit that evaluates a posture change of the spindle head based on each of the measurement results of the distance by the first measurement means and the second measurement means; and a control unit that controls a position of a tip of the spindle based on the evaluation result by the posture change evaluation unit.

Further preferably, the posture change evaluation unit evaluates a posture change of the spindle head by evaluating inclination of a linear line connecting the first column-side measurement target zone and the second column-side measurement target zone based on each of the measurement results of the distance by the first measurement means and the second measurement means.

In this case, employing a simple calculation process of evaluating inclination of the linear line allows for promptly evaluating a posture change of the two columns.

Preferably, the posture change evaluation unit stores predetermined reference distances between the first reference bar-side measurement target zone and the first column-side measurement target zone and between the second reference bar-side measurement target zone and the second column-side measurement target zone in each of a vertical direction and the two directions perpendicular to each other on the horizontal plane, and the posture change evaluation unit evaluates a posture change of the spindle head by comparing the reference distance and each of the distances measured by the first measurement means and the second measurement means.

Alternatively preferably, under a predetermined reference condition, the first measurement means measures, as a reference distance, a distance between the first reference bar-side measurement target zone and the first column-side measurement target zone in each of a vertical direction and the two directions perpendicular to each other on the horizontal plane and the second measurement means measures, as a reference distance, a distance between the second reference bar-side measurement target zone and the second column-side measurement target zone in each of a vertical direction and the two directions perpendicular to each other on the horizontal plane, and the posture change evaluation unit evaluates a posture change of the spindle head by comparing the reference distance and each of the distances measured by the first measurement means and the second measurement means.

Alternatively preferably, the first measurement means sequentially measures a distance between the first reference bar-side measurement target zone and the first column-side measurement target zone in each of a vertical direction and the two directions perpendicular to each other on the horizontal plane and the second measurement means sequentially measures a distance between the second reference bar-side measurement target zone and the second column-side measurement target zone in each of the vertical direction and the two directions perpendicular to each other on the horizontal plane, and the posture change evaluation unit sequentially evaluates a posture change of the spindle head by sequentially comparing each of the distances measured by the first measurement means and the second measurement means.

Preferably, the first reference bar and the second reference bar have a linear expansion coefficient of 1.0×10⁻⁶/° C. or less at 30° C. to 100° C.

In this case, thermal displacement rarely occurs in each of the reference bars and thus the distances between the reference bar-side measurement target zones and the two column-side measurement target zones can be handled as thermal displacement in the two column-side measurement target zones.

Preferably, the first measurement means and the second measurement means are displacement sensors of a contact type supported at the first column-side measurement target zone and the second column-side measurement target zone, respectively.

Alternatively, the first measurement means and the second measurement means may be displacement sensors of a contactless type supported at the first column-side measurement target zone and the second column-side measurement target zone, respectively.

Alternatively, the first measurement means and the second measurement means may be displacement sensors of a contact type supported at the first reference bar-side measurement target zone and the second reference bar-side measurement target zone, respectively. Alternatively, the first measurement means and the second measurement means may be displacement sensors of a contactless type supported at the first reference bar-side measurement target zone and the second reference bar-side measurement target zone, respectively.

### BRIEF DESCRIPTION OF DRAWINGS

FIG. 1 is a schematic perspective view of a machine tool of a first embodiment of the present invention.

FIG. 2 is a schematic side view of the machine tool in FIG. 1.

FIG. 3 is a schematic side view of a spindle head and a column seen from the right side in FIG. 1.

FIG. 4 is a schematic perspective view of the column used in the machine tool in FIG. 1.

FIG. 5 is a schematic side view of a reference bar used in the machine tool in FIG. 1.

FIG. 6 is a partial schematic perspective view illustrating details of an upper portion of the column in FIG. 4.

FIG. 7 is a schematic block diagram of a control device used in the machine tool in FIG. 1.

FIG. 8 is a diagram for explaining displacement of a measurement target zone and a spindle tip upon deformation of the column in FIG. 4.

FIG. 9 is a partial schematic perspective view illustrating details of an upper portion of a column used in a machine tool of a second embodiment of the present invention.

FIG. 10 is a diagram for explaining displacement of a measurement target zone and a spindle tip upon deformation of the column in FIG. 9.

FIG. 11 is a diagram for explaining evaluation principles of a posture change of the column of the machine tool of the second embodiment of the present invention.

FIG. 12 is a diagram in which the column in FIG. 11 in a deformed state is approximated to an arc.

FIG. 13 is schematic front view of a machine tool of the second embodiment of the present invention.

FIG. 14 is a schematic plan view of the machine tool in FIG. 13.

FIG. 15 is a schematic side view of a spindle head and a column seen from the right side in FIG. 13.

FIG. 16 is a schematic perspective view of the column used in the machine tool in FIG. 13.

FIG. 17 is schematic side view of a reference bar of the second embodiment of the present invention.

FIG. 18 is a partial schematic perspective view illustrating details of an upper portion of the column in FIG. 13.

FIG. 19 is schematic block diagram of a control device of the second embodiment of the present invention.

FIG. 20 is a partial schematic perspective view illustrating details of an upper portion of a column in a machine tool of a third embodiment of the present invention.

FIG. 21 is a schematic perspective view of a machine tool of a fourth embodiment of the present invention.

FIG. 22 is a partial schematic perspective view illustrating details of an upper portion of the machine tool and an inner portion of a first column in FIG. 21.

FIG. 23 is a schematic side view of a reference bar used in the machine tool in FIG. 21.

FIG. 24 is a schematic block diagram of a control device used in the machine tool in FIG. 21.

FIG. 25 is a diagram for explaining displacement of a measurement target zone and a spindle tip upon deformation of a column.

FIG. 26 is a partial schematic perspective view illustrating details of an upper portion of a column employed in an exemplary variation of the present invention.

FIG. 27 is a diagram for explaining displacement of a measurement target zone and a spindle tip upon deformation of the column in FIG. 26.

### DESCRIPTION OF EMBODIMENTS

A first embodiment of the present invention will be described in detail below with reference to the accompanying drawings.

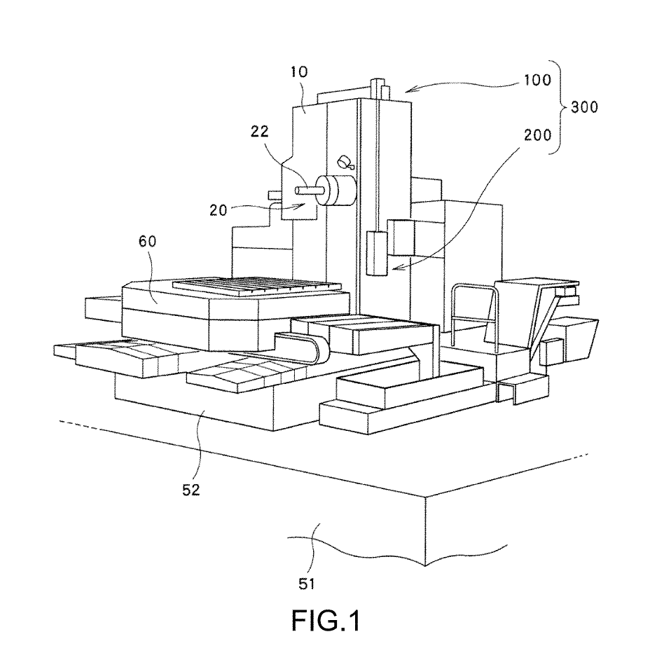

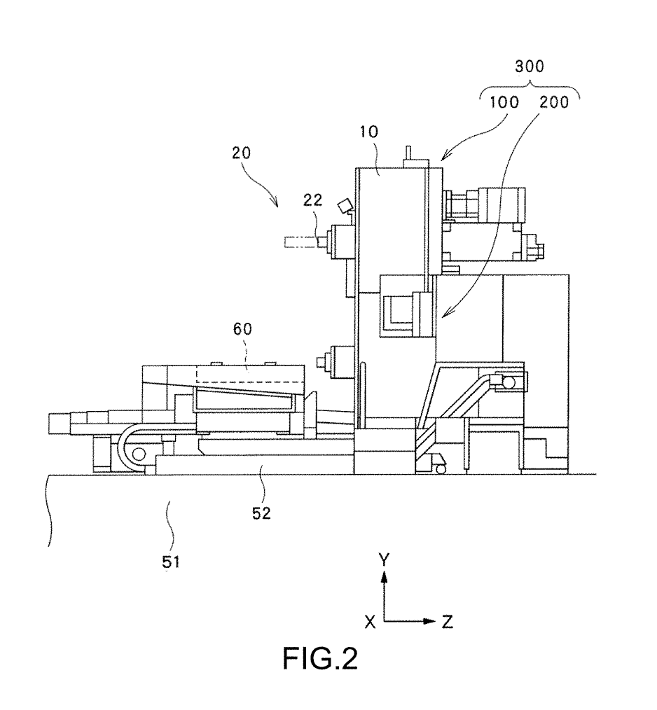

FIG. 1 is a schematic perspective view of a machine tool 300 of a first embodiment of the present invention. FIG. 2 is a schematic side view of the machine tool 300 in FIG. 1.

As illustrated in FIG. 1, the machine tool 300 of the present embodiment includes a processing machine 100 and a control device 200 that controls the processing machine 100.

The processing machine 100 of the present embodiment is for example a horizontal boring machine and includes a bed 52, a column 10 of a rectangular column shape fixed on the bed 52 in a vertically standing manner, and a spindle head 20 that is supported by the column 10 and supports a horizontal spindle (boring spindle) 22 for attaching a tool thereto as illustrated in FIGS. 1 and 2. Note that a horizontal spindle refers to a spindle having a horizontal rotation axis.

As illustrated in FIG. 1, the machine tool 300 of the present embodiment includes a foundation 51 and the bed 52 fixed over the foundation 51 via leveling blocks 53. The foundation 51 and the bed 52 are installed in the following manner for example. That is, a primary hole is provided on a floor surface at a position where the machine tool 300 of the present embodiment is installed. Concrete is then poured into the primary hole while a secondary hole is secured by a wood material or the like, thereby laying the foundation 51. Thereafter foundation bolts and the leveling blocks 53 are attached to the bed 52 and then the bed 52 is supported at a plurality of points such that the foundation bolt enters the secondary hole. The bed 52 is provisionally mounted on the foundation 51 by a jack (provisional centering tool) or the like. The bed 52 is then provisionally adjusted to be horizontal and concrete (and curing agent) is poured into the secondary hole, which completes construction of the foundation. When the concrete in the secondary hole cures, the jack or the like is removed and the leveling blocks 53 are adjusted, thereby securing structures (bed 52 and respective columns 10 and 11) are to be horizontal. As apparent from the above, inclination of the bed 52 of the present embodiment with respect to the foundation 51 can be adjusted (corrected) by adjusting the leveling blocks 53.

A spindle 22 of the present embodiment has for example a columnar shape with a diameter of 110 mm and a tip portion thereof (left end portion in FIG. 2) can be attached with a desired processing tool in a detachable manner. In the present embodiment, the spindle 22 is capable of rotating about an axis at, for example, 5 to 3000 min-1 by a driving mechanism included in the spindle head 20 and also can be fed in an axial direction by 500 mm at the maximum, for example.

The bed 52 is further provided with a saddle (not illustrated) and a mobile table 60 whereon a workpiece is placed is installed on the saddle. The table 60 moves in an X axis direction relative to the saddle on a horizontal plane and the saddle moves in a Z axis direction relative to the bed 52, thereby positioning is performed on the spindle 22 with respect to the workpiece on a horizontal plane. As will be described later, the spindle head 20 of the present embodiment is movable in the vertical direction along the column 10 (vertical direction in FIGS. 1 and 2). Positioning of the spindle 22 with respect to a workpiece in the vertical direction is performed by this movement.

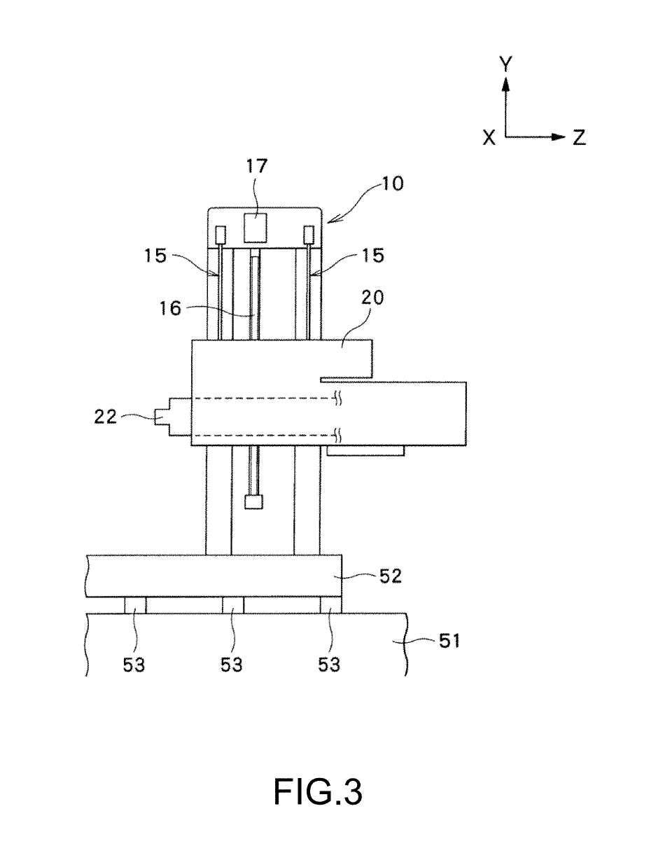

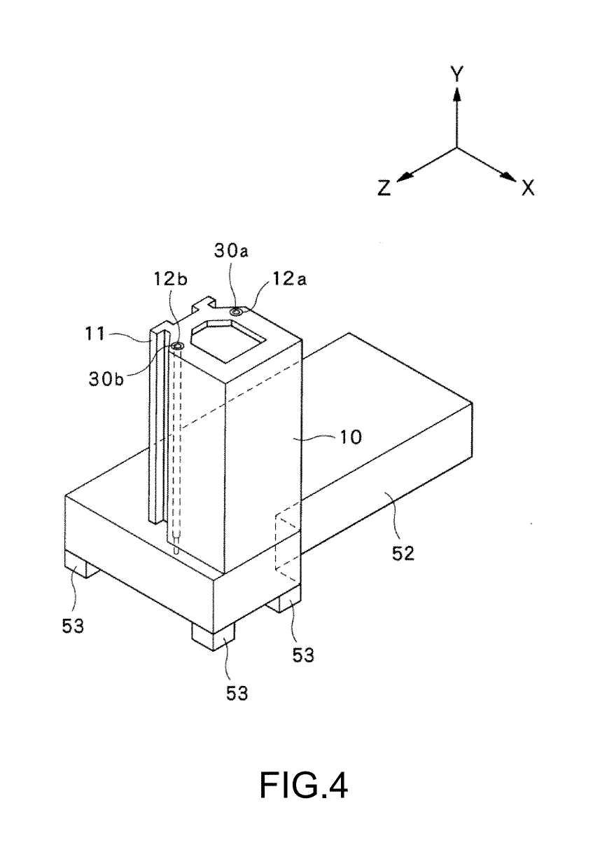

FIG. 3 is a schematic side view of the spindle head 20 and the column 10 seen from the right side in FIG. 1. As illustrated in FIG. 3, the spindle head 20 of the present embodiment is disposed on a side surface of the column 10 with the axis of the spindle 22 kept horizontal. The spindle head 20 of the present embodiment is movable in the vertical direction (vertical direction in FIG. 3) by a known driving mechanism such as a ball screw 16 and a servo motor 17 that drives the ball screw 16. In the present embodiment, in order to support vertical movement of the spindle head 20 by the driving mechanism, the spindle head 20 is hung by being coupled to one end of wire 15 vertically suspended via a pulley included in an upper portion of the processing machine 100, the other end of which coupled to a balance weight disposed inside the column 10. The spindle head 20 further includes guided portions (groove portions) in an area facing the column 10. The guided portions are engaged to guiding portions (rails) 11 (see FIG. 4) integrally included on one side surface of the column 10 while the spindle head 20 is hung by the wire 15.

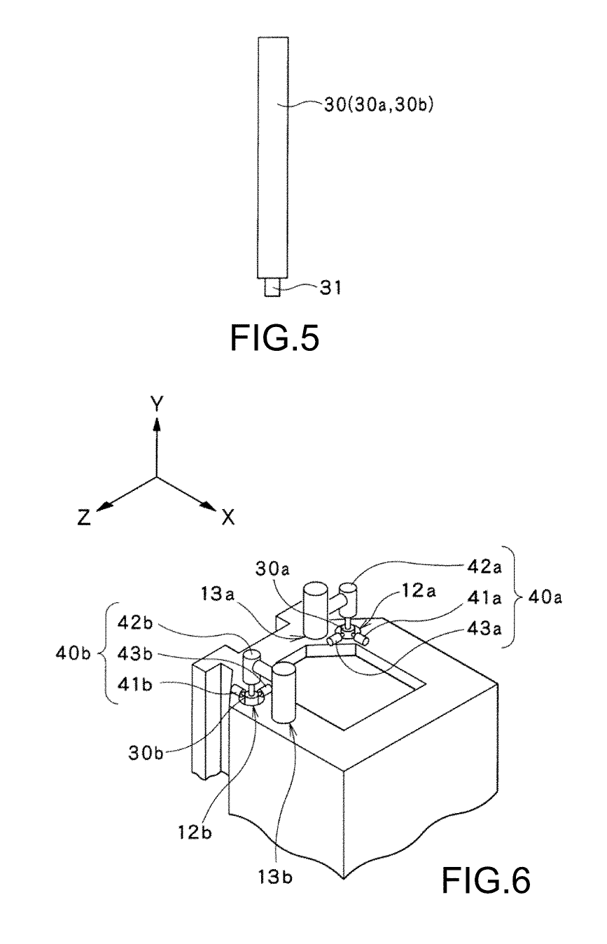

FIG. 4 is a schematic perspective view of the column 10 used in the machine tool 300 in FIG. 1. FIG. 5 is a schematic side view of a reference bar 30 used in the machine tool 300 in FIG. 1. As illustrated in FIG. 4, the column 10 of the present embodiment is formed with a first through hole 12a and a second through hole 12b in the vertical direction. In the present embodiment, the first through hole 12a and the second through hole 12b are included in the vicinity of corner portions (vertices of a rectangular on a cross section) of the column 10 along the axial direction (Y axis direction in FIG. 4) of the spindle 20.

As illustrated in FIG. 4, the first through hole 12a is inserted with a first reference bar 30a and the second through hole 12b is inserted with a second reference bar 30b in the present embodiment. As illustrated in FIG. 5, the first and the second reference bars 30a and 30b of the present embodiment have a columnar shape formed with a male screw portion 31 at a lower end portion thereof. The male screw portion 31 is screwed to a female screw portion included in the bed 52. The column 10 of the present embodiment is supported on the bed 52 in a fixed manner while the leveling blocks 53 fixed to the foundation 51 are adjusted such that the spindle head 20 vertically moves. In the present embodiment, the first and the second reference bars 30a and 30b are screwed to the bed 52 in such a manner not interfering with an inner peripheral surface of the first through hole 12a and the second through hole 12b upon normal use of the machine tool 300. In other embodiments, the first and the second reference bars 30a and 30b may be independently fixed to the foundation 51 via blocks that are ensured to be horizontal.

The first and the second reference bars 30a and 30b of the present embodiment have a linear expansion coefficient smaller than that of the column 10. The linear expansion coefficient at 30° C. to 100° C. is 0.29×10⁻⁶/° C.

FIG. 6 is a partial schematic perspective view illustrating details of an upper portion of the column 10 in FIG. 4. As illustrated in FIG. 6, a first measurement target zone 13a and a second measurement target zone 13b in the upper portion of the column 10 are provided with a first and a second displacement sensors 40a and 40b of a contact type. The first displacement sensor 40a of the present embodiment includes a first Y axis displacement sensor 42a that detects displacement or a distance in the vertical direction (Y axis direction in FIG. 6) and a first X axis displacement sensor 41a and a first Z axis displacement sensor 43a that detect displacement or distances in two directions perpendicular to each other on a horizontal plane (X axis direction and Z axis direction in FIG. 6). The second displacement sensor 40b of the present embodiment includes a second Y axis displacement sensor 42b that detects displacement or a distance in the Y axis direction and a second X axis displacement sensor 41b that detects displacement or a distance in the X axis direction and a second Z axis displacement sensor 43b. By the first and the second displacement sensors 40a and 40b, displacement or distances in the vertical direction and on a horizontal plane between the first measurement target zone 13a and the second measurement target zone 13b and measurement target zones of the first and the second reference bars 30a and 30b, respectively, are measured. The first and the second displacement sensors 40a and 40b of the present embodiment employ a digital sensor with a high accuracy. The first and the second displacement sensors 40a and 40b are illustrated while enlarged in FIG. 6.

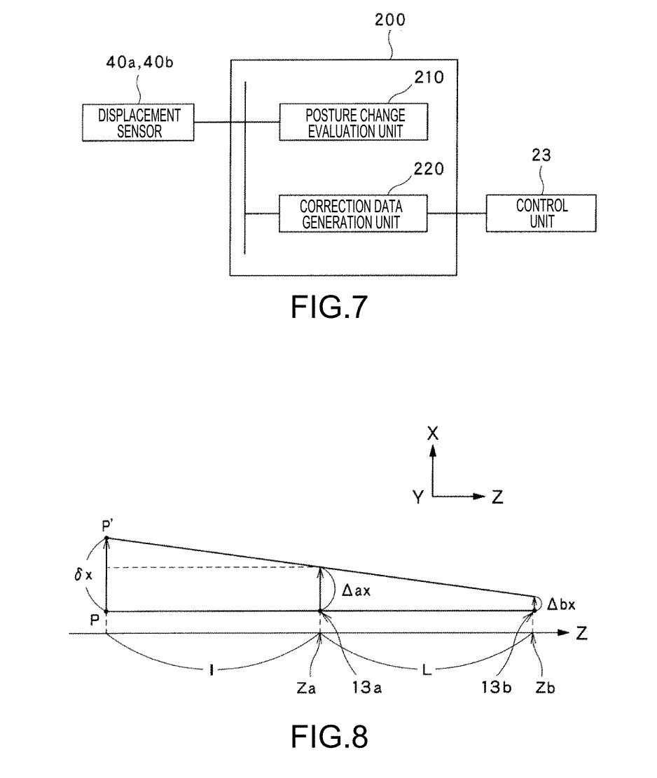

FIG. 7 is a schematic block diagram of the control device 200 used in the machine tool 300 in FIG. 1. As illustrated in FIG. 7, an output signal from the first and the second displacement sensors 40a and 40b is transmitted to the control device 200 in the present embodiment. As illustrated in FIG. 7, the control device 200 includes a posture change evaluation unit 210 that evaluates a posture change of the column 10 based on measurement results by the first and the second displacement sensors 40a and 40b and a correction data generation unit 220 that generates data for correcting displacement (positional shift) of the spindle tip based on the evaluation result by the posture change evaluation unit 210. The correction data generation unit 220 is connected to a control unit 23 that controls a position of the spindle tip and thus the generated correction data is output to the control unit 23.

In the present embodiment, distances between the measurement target zones in the upper portions of the first and the second reference bars 30a and 30b and the first measurement target zone 13a and the second measurement target zone 13b on a top surface of the column 10, respectively, in the vertical direction (Y axis direction in FIG. 6) and in the two directions perpendicular to each other on a horizontal plane (X axis direction and Z axis direction in FIG. 6) are measured by the first and the second displacement sensors 40a and 40b under a predetermined reference condition for example upon accuracy adjustment of the processing machine 100. Specifically, distances ax and bx in the X axis direction between the measurement target zones in the upper portions of the first and the second reference bars 30a and 30b and the first measurement target zone 13a and the second measurement target zone 13b on the top surface of the column 10, respectively, are measured by the first X axis displacement sensor 41a and the second X axis displacement sensor 41b and thereby rightward inclination and leftward inclination of the spindle are confirmed. Distances ay and by in the Y axis direction between the measurement target zones in the upper portions of the first and the second reference bars 30a and 30b and the first measurement target zone 13a and the second measurement target zone 13b on the top surface of the column 10, respectively, are measured by the first Y axis displacement sensor 42a and the second Y axis displacement sensor 42b and thereby elongation or shrinkage of the column is confirmed. Distances az and bz in the Z axis direction between the measurement target zones in the upper portions of the first and the second reference bars 30a and 30b and the first measurement target zone 13a and the second measurement target zone 13b on the top surface of the column 10, respectively, are measured by the first Z axis displacement sensor 43a and the second Z axis displacement sensor 43b and thereby forward inclination and backward inclination of the spindle are confirmed. The measured respective distances ax, ay, and az and bx, by, and bz are stored in the posture change evaluation unit 210 in the control device 200 as reference distances and thereby specific displacement as described above and a correction value therefor are calculated.

Next, operations of the machine tool 300 of the present embodiment will be described.

First, a desired processing tool (e.g. milling cutter) is attached to the spindle tip. Next, a user installs a workpiece to be processed on the table 60 and inputs desired processing data to the control device 200. The processing machine 100 is controlled based on the processing data. Next, the table 60 mounted with the workpiece moves in the X axis direction on the saddle based on the processing data and the saddle supporting the table 60 moves in the Z axis direction on the bed 52. In this manner, positioning of the workpiece on a horizontal plane is performed and the spindle head 20 is transferred to a desired position in the vertical direction via the driving mechanism as described above. The spindle 22 is then fed in the horizontal direction toward the workpiece.

Thereafter, rotation of the spindle 22 is initiated by a spindle driving mechanism in the spindle head 20 and supply of cutting fluid toward a tip of the processing tool is initiated, thereby initiating processing of the workpiece.

In the present embodiment, the first and the second displacement sensors 40a and 40b measure distances ax′, ay′, and az′ and bx′, by′, and bz′, respectively, between the measurement target zones of the first and the second reference bars 30a and 30b and the first measurement target zone 13a and the second measurement target zone 13b of the column 10, respectively, in the X, Y, and the Z axis directions before initiation of processing of the workpiece. The posture change evaluation unit 210 in the control device 200 then evaluates displacement of the first measurement target zone 13a and the second measurement target zone 13b relative to the reference distances in the X, Y, and the Z axis directions. That is, displacement of the first measurement target zone 13a relative to each of the reference distances in the X, Y, and the Z axis directions is represented by ax′−ax (=Δax), ay′−ay (=Δay), and az′−az (=Δaz). Displacement of the second measurement target zone 13b relative to each of the reference distances in the X, Y, and the Z axis directions is represented by bx′−bx (=Δbx), by′−by (=Δby), and bz′−bz (=Δbz).

The posture change evaluation unit 210 evaluates undesired displacement δ of the spindle tip due to a posture change of the spindle head 20 attributable to deformation of the column 10 for each of the X, Y, and the Z axis directions. Regarding this evaluation, FIG. 8 illustrates a diagram for explaining displacement of the first measurement target zone 13a and the second measurement target zone 13b and the spindle tip upon deformation of the column 10 in FIG. 4. First, a posture change of the spindle head 20 in the X axis direction will be examined. As illustrated in FIG. 8, when a Z coordinate of the second measurement target zone 13b is denoted as Zb, a Z coordinate of the measurement target zone 13a is denoted as Za, a distance from the first measurement target zone 13a to a position of the nominal spindle 22 without considering a posture change of the column 10, specifically, to a reference position P defined for a driving system that drives the spindle 22 is denoted as I, a linear distance connecting the first measurement target zone 13a and the second measurement target zone 13b without considering a posture change of the column 10 is denoted as L, and a distance (displacement) between an actual spindle tip P′ and the reference position P of the nominal spindle 22 with consideration to a posture change of the column 10 is denoted as δ, an X axis direction component δx of displacement δ is represented by the following mathematical formula. When actual displacement of the spindle tip is calculated, it is preferable to consider influence of inclination of the spindle itself in addition to displacement according to the present calculation.

δx=Δax+mxl (where mx=(Δax−Δbx)/L) [Mathematical Formula 1]

The result above examined is similar to the case of evaluating a posture change of the spindle head 20 in the Y axis direction. That is, a component δy of displacement δ in the Y axis direction is represented by the following mathematical formula.

δy=Δay+myl (where my=(Δay−Δby)/L) [Mathematical Formula 2]

Evaluation in the Z axis direction can be also performed in a similar manner.

δz=Δaz+mzl (where mz=(Δaz−Δbz)/L) [Mathematical Formula 3]

In the above respective mathematical formulas, δ is calculated while decomposed into orthogonal three axes. Note that the first measurement target zone 13a and the second measurement target zone 13b both exist on the top surface of one column 10 and thus, physically, Δaz and Δbz cannot be entirely different. Therefore, the machine tool 300 of the present embodiment is preferably provided with a monitoring system that gives an alarm when an abnormal posture change occurs such as a change of a certain level or more in a distance between the first measurement target zone 13a and the second measurement target zone 13b.

The evaluation result by the posture change evaluation unit 210 is transmitted to the correction data generation unit 220 and the correction data generation unit 220 generates correction data for correcting displacement of the spindle tip. Various known algorithms may be employed for generation itself of the correction data. The generated correction data is transmitted to the control unit 23 that controls (corrects) a position of the spindle tip. The control unit 23 then controls (corrects) a position of the spindle tip according to the received correction data. Various known algorithms may be employed as for specific contents of control by the control unit 23.

According to the present embodiment as described above, directly measuring distances between the measurement target zones of the first and the second reference bars 30a and 30b and the first measurement target zone 13a and the second measurement target zone 13b of the column 10 in the vertical direction (Y axis direction) and in two directions perpendicular to each other on a horizontal plane (X axis direction and Z axis direction) by the first and the second displacement sensors 40a and 40b allows for measuring thermal displacement of the column 10 at a low cost with a high accuracy. This allows for measuring a posture change of the column 10 at a low cost with a high accuracy, thereby allowing for providing the machine tool 300 capable of correcting displacement of the spindle tip attributable to the posture change and implementing precise processing of a workpiece.

Especially, according to the present embodiment, directly measuring distances between the measurement target zones of the first and the second reference bars 30a and 30b and the first measurement target zone 13a and the second measurement target zone 13b of the column 10 in the X, Y, and the Z axis directions by the first and the second displacement sensors 40a and 40b allows for measuring thermal displacement of the column 10 at a low cost with a higher accuracy. This allows for measuring a posture change of the column 10 at a low cost with an even higher accuracy, thereby allowing for providing the machine tool 300 capable of correcting displacement of the spindle tip attributable to the posture change and implementing precise processing of a workpiece.

In the present embodiment, the first measurement target zone 13a and the second measurement target zone 13b apart from each other by a predetermined distance on the top surface of the column 10 are associated with the measurement target zones of the first and the second reference bars 30a and 30b, the two directions perpendicular to each other on a horizontal plane are an axial direction of the spindle 22 and a direction perpendicular to the axial direction of the spindle 22 on the horizontal plane, the first and the second displacement sensors 40a and 40b measure distances between the measurement target zone of the first reference bar 30a and the first measurement target zone 13a of the column 10 in each of the vertical direction, the axial direction of the spindle 22, and a direction perpendicular to the axial direction of the spindle 22 on the horizontal plane and between the measurement target zone of the second reference bar 30b and the second measurement target zone 13b of the column 10 in each of the vertical direction and the direction perpendicular to the axial direction of the spindle 22 on the horizontal plane, and the posture change evaluation unit 210 evaluates a posture change of the spindle head 20 by evaluating inclination of a linear line connecting the first measurement target zone 13a and the second measurement target zone 13b of the column 10 based on each of the measurement results of the distances by the first and the second displacement sensors 40a and 40b. Due to this, a calculation process is simple and thus a posture change of the column can be promptly evaluated.

The first and the second displacement sensors 40a and 40b measure distances between the measurement target zones of the first and the second reference bars 30a and 30b and the first measurement target zone 13a and the second measurement target zone 13b of the column 10, respectively, in the X, Y, and the Z axis directions before initiation of processing of the workpiece. The posture change evaluation unit 210 evaluates a posture change of the column 10 by comparing the measured respective distances to the respective reference distances of the first measurement target zone 13a and the second measurement target zone 13b stored in the posture change evaluation unit 210. Therefore, it is easy to evaluate displacement in each axis direction.

The first and the second reference bars 30a and 30b have a linear expansion coefficient of 0.29×10⁻⁶/° C. at 30° C. to 100° C. In this case, thermal displacement rarely occurs in the first and the second reference bars 30a and 30b and thus the distances between the measurement target zones of the first and the second reference bars 30a and 30b and the first measurement target zone 13a and the second measurement target zone 13b of the column 10 in the X, Y, and the Z axis directions can be handled as thermal displacement in the first measurement target zone 13a and the second measurement target zone 13b of the column 10.

In the present embodiment, the first displacement sensor 40a and a second displacement sensor 40b of a contact type supported at the first measurement target zone 13a and the second measurement target zone 13b of the column 10 are employed as the measurement means. Therefore, distances between the measurement target zones of the respective reference bars 30a and 30b and the first measurement target zone 13a and the second measurement target zone 13b of the column 10 in the X, Y, and the Z axis directions can be easily measured with a high accuracy.

Note that, physically, Δaz and Δbz cannot be entirely different as described above. Therefore, the second Z axis displacement sensor 43b may not be included and a posture change in the spindle head 20 can be evaluated while assuming that displacement Δaz generated in the first measurement target zone 13a is also generated in the measurement target zone 13b. That is, in this case, component δz of displacement δ in the Z axis direction is represented by the following mathematical formula.

δz=Δaz [Mathematical Formula 4]

Alternatively, component δz of displacement δ in the Z axis direction may be assumed equivalent to an average value of Δaz and Δbz ((Δaz+Δbz)/2) or to Δbz. Note that the first measurement target zone 13a is positioned closer to the spindle tip than from the second measurement target zone 13b and thus it is estimated that displacement of the spindle tip (positional shift) can be evaluated more precisely.

Note that such a correction calculation of displacement of the spindle tip based on FIG. 8 is merely an example and thus displacement of the spindle tip may be evaluated by another method. For example, the above may be substituted by another similar mathematical formula derived by a measurement value of the displacement sensor and measurement data of displacement of the spindle tip acquired in advance in a previous test.

Note that the machine tool 300 of the present embodiment is exemplified by the machine tool having a single column 10 and thereby explained; however, the machine tool may include a plurality of columns as long as the machine tool includes a horizontal spindle. For example in a machining center having two columns, installing a pair of reference bar and displacement sensor to each of the two columns allows for evaluating displacement of the spindle tip based on the calculation formulas described above. Alternatively, a plurality of pairs (e.g. two pairs) of reference bar and displacement sensor may be installed to each of the two columns. Displacement of the measurement target zone may be determined for each of the columns based on the measurement results by the displacement sensors in the plurality of pairs. Displacement of the spindle tip may be evaluated by applying the displacement to the calculation formulas described above.

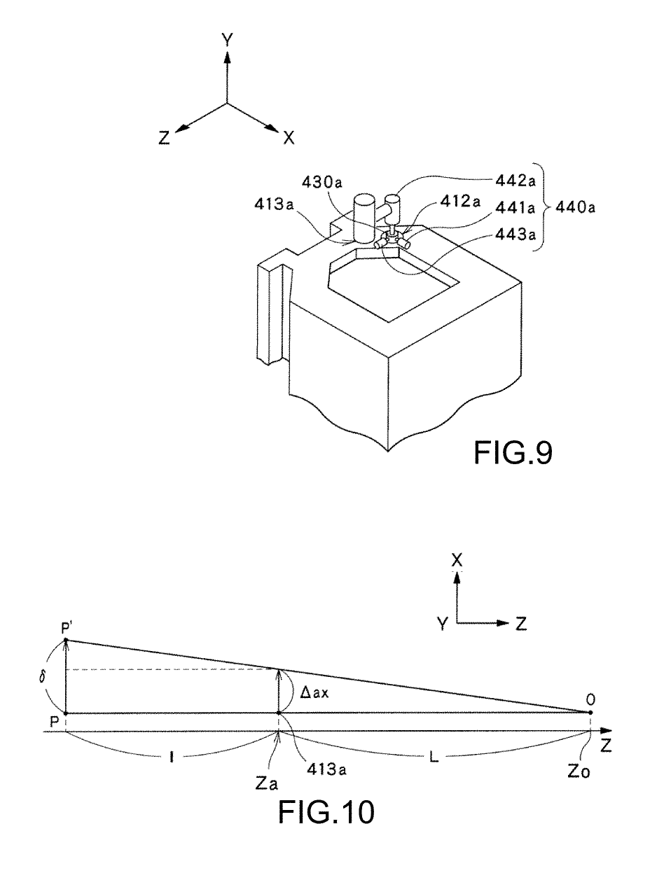

Note that in the machine tool having a single column, installing a pair of reference bar and displacement sensor to the column allows for evaluating displacement of the spindle tip. An exemplary method for evaluating displacement of a spindle tip of this exemplary variation will be described with reference to FIGS. 9 and 10.

FIG. 9 is a partial schematic perspective view illustrating details of an upper portion of a column 410 used in a machine tool of a second embodiment of the present invention. FIG. 10 is a diagram for explaining displacement δ of a measurement target zone 413a and a spindle tip upon deformation of the column 410 in FIG. 9.

The column 410 of the present embodiment is formed with a through hole 412a in the vertical direction (Y axis direction in FIG. 9) only at a corner portion closest to a spindle head and a reference bar 430a is inserted in the through hole 412a. On a top surface of the column 410, a measurement target zone 413a is associated with the reference bar 430a. The measurement target zone 413a is installed with a displacement sensor 440a of a contact type and a distance between a measurement target zone of the reference bar 430a and the measurement target zone 413a of the column 410 in each of the vertical direction and two directions perpendicular to each other on a horizontal plane (X axis direction and Z axis direction in FIG. 9) is measured. Specifically, the displacement sensor 440a of the present embodiment also includes a Y axis displacement sensor 441a that detects displacement or a distance in the vertical direction and an X axis displacement sensor 442a and a Z axis displacement sensor 443a that detect displacement or distances in two directions perpendicular to each other on a horizontal plane. The displacement sensor 440a measures displacement or a distance between the measurement target zone 413a and the measurement target zone of the reference bar 430a in each of the X, Y, and the Z axis directions.

For example upon accuracy adjustment of the processing machine, the displacement sensor 440a measures in advance distances ax, ay, and az between the measurement target zone in the upper portion of the reference bar 430a and the measurement target zone 413a on the top surface of the column 410 in each of the X, Y, and the Z axis directions under a predetermined reference condition. The respective distances ax, ay, and az are stored in a posture change evaluation unit 210 (see FIG. 7) in the control device 200 (see FIG. 7) as reference distances. The posture change evaluation unit 210 also prestores a reference coordinate (coordinate of point O in FIG. 10) which is positioned on the top surface of the column 410 and is different from the measurement target zone 413a. As described later, a posture change of the spindle head 20 is evaluated based on displacement of the measurement target zone 413a with respect to this reference coordinate. The reference coordinate is set such that a linear line connecting the reference coordinate and the measurement target zone 413a is parallel to the Z axis. Other configurations are similar to those of the machine tool 300 of the first embodiment and thus detailed descriptions thereon are omitted.

Upon evaluation of displacement of the spindle tip, the displacement sensor 440a measures distances ax′, ay, and az′ between the measurement target zone of the reference bar 430a and the measurement target zone 413a of the column 410 in each of the X, Y, and the Z axis directions before initiation of processing of a workpiece also in the present variation. The posture change evaluation unit 210 in the control device 200 then evaluates displacement of the measurement target zone 413a of the column 410 with respect to the reference distance in each of the X, Y, and the Z axis directions (ax′−ax (=Δax), ay′−ay (=Δay), and az′−az (=Δaz)).

Based on the above evaluation results, the posture change evaluation unit 210 evaluates a posture change of the column 410. Regarding this evaluation, FIG. 10 illustrates a diagram for explaining displacement of the measurement target zone 413a and the spindle tip upon deformation of the column 410 in FIG. 9. First, a posture change of the spindle head 20 in the X axis direction will be examined. As illustrated in FIG. 10, when a Z coordinate of the point O is denoted as ZO, a Z coordinate of the measurement target zone 413a is denoted as Za, a distance from the measurement target zone 413a to the nominal spindle tip P without considering a posture change of the column 410 is denoted as I, a linear distance connecting the measurement target zone 13a and the reference coordinate without considering a posture change of the column 10 is denoted as L, and a distance (displacement) between an actual spindle tip P′ and the nominal spindle tip P with consideration to a posture change of the column 410 is denoted as δ, an X axis direction component δx of displacement δ is represented by the following mathematical formula.

δx=Δax+mxl (where mx=Δax/L) [Mathematical Formula 5]

The result above examined is similar to the case of evaluating a posture change of the spindle head 20 in the Y axis direction. That is, a component δy of displacement δ in the Y axis direction is represented by the following mathematical formula.

δy=Δay+myl (where my=Δay/L) [Mathematical Formula 6]

Meanwhile, as for the Z axis direction, a posture change of the spindle head 20 is evaluated while displacement Δaz occurring in the measurement target zone 413a is regarded as also occurring at point O. This is because both of the measurement target zone 413a and point O are on the column 410 and thus a distance between the measurement target zone 413a and point O in the Z axis direction is conserved. That is, a component δz of displacement δ in the Z axis direction is represented by the following mathematical formula.

δz=Δaz [Mathematical Formula 7]

Similarly to the first embodiment, the evaluation result by the posture change evaluation unit 210 is transmitted to the correction data generation unit 220 and the correction data generation unit 220 generates correction data for correcting displacement of the spindle tip. The generated correction data is transmitted to the control unit 23 that controls (corrects) a position of the spindle tip. The control unit 23 then controls (corrects) a position of the spindle tip according to the received correction data.

Also in such a variation as described above, directly measuring distances between the measurement target zone of the reference bar 430a and the measurement target zone 413a of the column 410 in the vertical direction (Y axis direction) and two directions perpendicular to each other on a horizontal plane (X axis direction and Z axis direction) by the displacement sensor 440a allows for measuring thermal displacement of the column 410 at a low cost with a high accuracy. This allows for measuring a posture change of the column 410 at a low cost with a high accuracy, thereby allowing for providing a machine tool capable of correcting displacement of a spindle tip attributable to the posture change and implementing precise processing of a workpiece.

Note that descriptions are given assuming that the column is fixed on a foundation 51 or a bed 52 in the descriptions of the present embodiment or the variation described above; however, the machine tool may be of a type where a column moves on a foundation 51 or a bed 52. In this case, a guide member (e.g. bearing) that limits displacement of the reference bar in the horizontal direction may be provided in the through hole included in the column and displacement of the spindle tip only in the Y axis direction can be thereby evaluated.

When a machine tool includes two movable columns, each of the columns may be installed with a pair of reference bar and displacement sensor or may be installed with a plurality of pairs of reference bars and displacement sensors. In either case, displacement of a spindle tip can be evaluated based on the calculation formulas described in the present embodiment. Alternatively, displacement of a spindle tip may be evaluated based on another similar formula derived by a measurement value of the displacement sensor and measurement data of displacement in a test.

Also when a machine tool includes a single movable column, the column may be installed with a pair of reference bar and displacement sensor or may be installed with a plurality of pairs of reference bars and displacement sensors. Also in these case, displacement of a spindle tip can be evaluated based on the calculation formulas described in the present embodiment and the aforementioned exemplary variations. Alternatively, displacement of a spindle tip may be evaluated based on another similar formula derived by a measurement value of the displacement sensor and measurement data of displacement in a test.

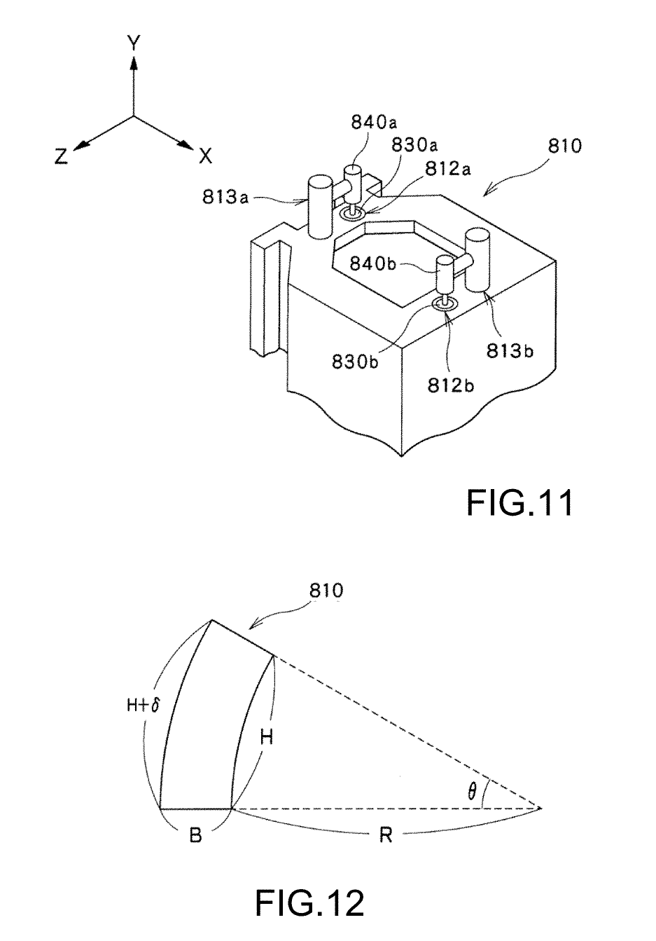

Next, before describing the machine tool of the second embodiment of the present invention with reference to FIGS. 11 to 20, evaluation principles of displacement (posture change) of a column 810 based on two displacement sensors 840a and 840b will be described with reference to FIGS. 11 and 12. FIG. 11 is a diagram for explaining evaluation principles of a posture change of the column 810 of the present embodiment. FIG. 12 is a diagram in which the column 810 in FIG. 11 in a deformed state is approximated to an arc.

The column 810 is formed with two through holes 812a and 812b extending in the vertical direction on left and right sides of a wall portion on a left front as illustrated in FIG. 11. Reference bars 830a and 830b are inserted in the through holes 812a and 812b, respectively. In an upper portion of the column 810, two measurement target zones 813a and 813b are associated with the reference bars 830a and 830b. The measurement target zones 813a and 813b are installed with the displacement sensors 840a and 840b of a contact type, respectively, and measures distances in the vertical direction between the measurement target zones of the reference bars 830a and 830b and the measurement target zones 813a and 813b of the column 810.

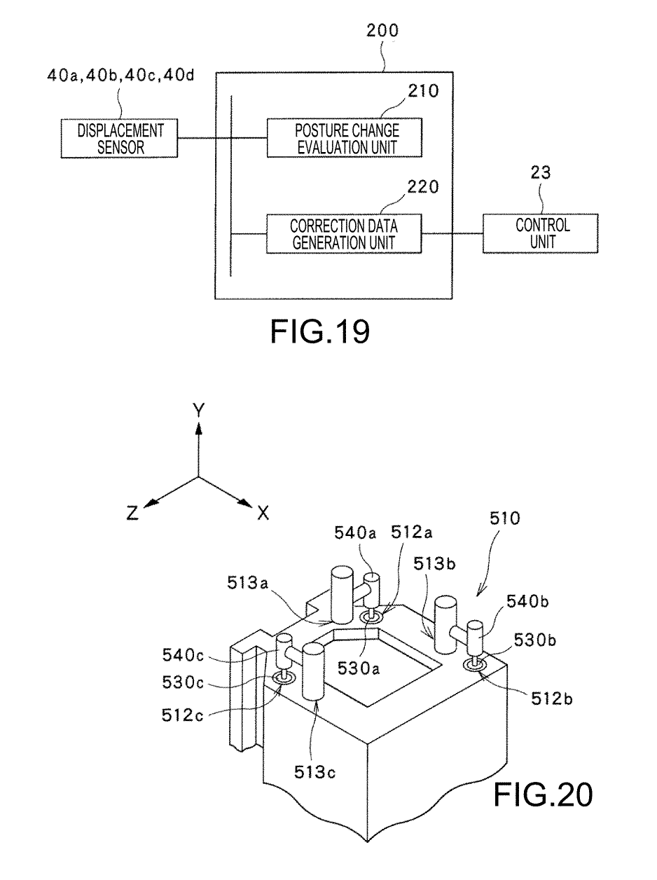

For example upon accuracy adjustment of the processing machine, distances a and b between the measurement target zones on an upper surface of the reference bars 830a and 830b and the two measurement target zones 813a and 813b on a top surface of the column 810, respectively, in the vertical direction are measured in advance by the displacement sensors 840a and 840b under a predetermined reference condition. The measured distances a and b are stored in the posture change evaluation unit 210 (see FIG. 19) in the control device 200 as reference distances a and b.

Next, distances a′ and b′ between the measurement target zones of the reference bars 830a and 830b and the two measurement target zones 813a and 813b of the column 810, respectively, in the vertical direction are measured by the displacement sensors 840a and 840b before initiation of processing of a workpiece W.

The posture change evaluation unit 210 in the control device 200 then evaluates displacement of the respective measurement target zones 813a and 813b of the column 810 in the vertical direction (a′−a (=Δa), and b′−b (=Δb)). The posture change evaluation unit 210 further evaluates Δa−Δb (=δ).

Based on the above evaluation results, the posture change evaluation unit 210 evaluates a posture change of the column 810 for example in the following manner. That is, the column 810 here can be approximated by an arc (central angle θ) with an inner periphery H, an outer periphery H+δ, an inner diameter R, and an outer diameter R+B as illustrated in FIG. 12 when seen from a negative side to a positive side in the Z axis (from an upper right direction in FIG. 11). Relational expressions of Rθ=H and (R+B)θ=H+δ hold. Solving these two equations for θ results in obtaining θ as a function having δ as a parameter. That is a relation of θ=f(δ) . . . (1) is obtained. Where H represents the length (height) of the column 810 and B represents the width of the column 810.

The posture change evaluation unit 210 evaluates θ by substituting the evaluated δ (=Δa−Δb) in the above mathematical formula (1). Then inclination of the column 810 is approximated by a linear line based on the θ, thereby a posture change of the column 810 in the X axis direction (see FIG. 11) is evaluated.

Next, embodiments of the present invention will be described in detail.

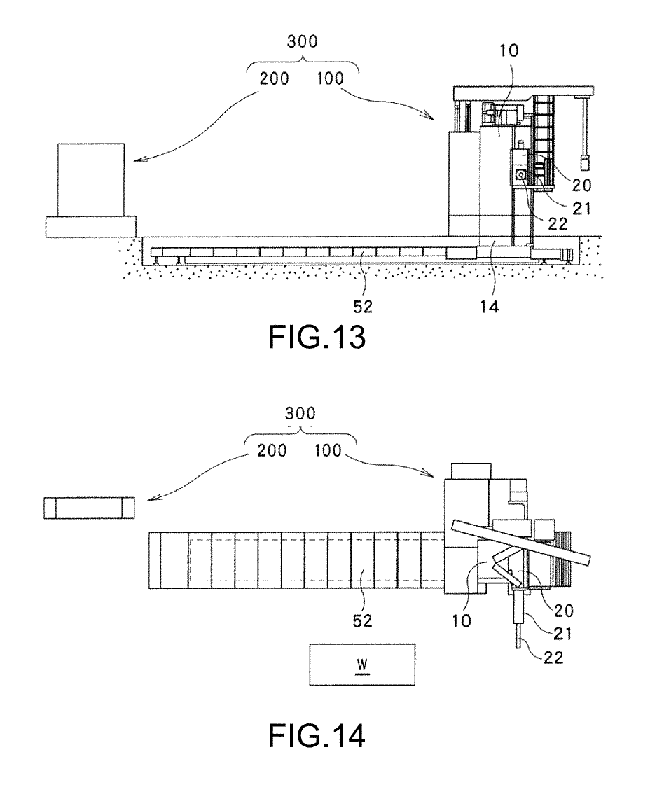

FIG. 13 is schematic front view of a machine tool 600 of the second embodiment of the present invention. FIG. 14 is a schematic plan view of the machine tool 600 in FIG. 13.

As illustrated in FIG. 13, the machine tool 600 of the present embodiment includes a processing machine 100 and a control device 200 that controls the processing machine 100.

The processing machine 100 of the present embodiment is for example a horizontal boring machine and includes a spindle head 20 having a ram 21 that supports the spindle (boring spindle) 22 extending in the horizontal direction and a rectangular column 10 that supports the spindle head 20 on a side surface thereof as illustrated in FIGS. 13 and 14. A spindle 22 of the present embodiment has a columnar shape with a diameter of 180 mm and a front end portion thereof (downward in FIG. 14) can be attached with a desired processing tool in a detachable manner.

In the present embodiment, the ram 21 supporting the spindle 22 has a rectangular columnar shape having a square cross-section with sides of substantially 500 mm and slidably supports (capable of feeding) the spindle 22 in the spindle direction (vertical direction in FIG. 14). The ram 21 itself is inserted in a hole portion having a square cross-section with sides of substantially 500 mm formed in the spindle head 20 of and is thereby horizontally supported. The ram 21 is slidable (can be fed) with respect to the spindle head 20 in the axial direction of the spindle 22.

In the present embodiment, the ram 21 can be fed by 1400 mm at the maximum with respect to the spindle head 20. Furthermore, the spindle (boring spindle) 22 can be fed by 1200 mm at the maximum with respect to the ram 21. That is, a processing tool attached to a tip of the spindle 22 can be transferred in the spindle direction by a length of 2600 mm at the maximum with respect to the processing machine 100.

The column 10 of the present embodiment is supported on the bed 52 via a pedestal 14 as illustrated in FIGS. 13 and 14. The bed 52 is movable in the horizontal direction (horizontal direction in FIGS. 13 and 14) by a known driving mechanism provided to the pedestal 14.

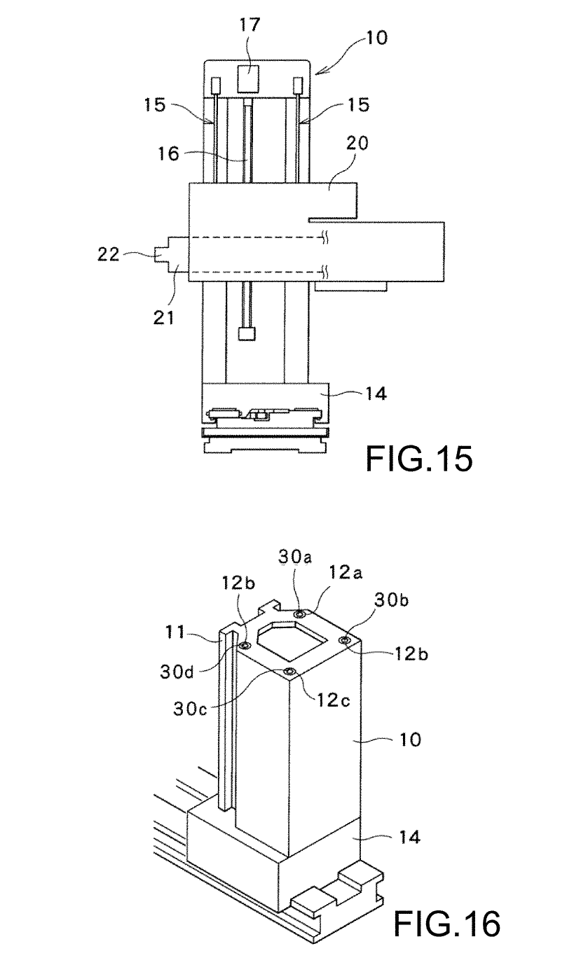

FIG. 15 is a schematic side view of the spindle head 20 and the column 10 seen from the right side in FIG. 13. As illustrated in FIG. 15, the spindle head 20 of the present embodiment is disposed on a side surface of the column 10 with the axis of the spindle 22 kept horizontal. The column 10 of the present embodiment is made of metal and has a rectangular columnar shape having substantially a square cross-section with a side of 1600 mm and a height of 6650 mm. The spindle head 20 of the present embodiment is movable in the vertical direction (vertical direction in FIG. 13) by a known driving mechanism such as a ball screw 16 and a servo motor 17 that drives the ball screw 16. In the present embodiment, in order to support vertical movement of the spindle head 20 by the driving mechanism, the spindle head 20 is hung by being coupled to one end of wire 15 vertically suspended via a pulley included in an upper portion of the processing machine 100, the other end of which coupled to a balance weight disposed inside the column 10. The spindle head 20 further includes guided portions (groove portions) in an area facing the column 10. The guided portions are engaged to guiding portions (rails) 11 (see FIG. 16) integrally included on one side surface of the column 10 while the spindle head 20 is hung by the wire 15.

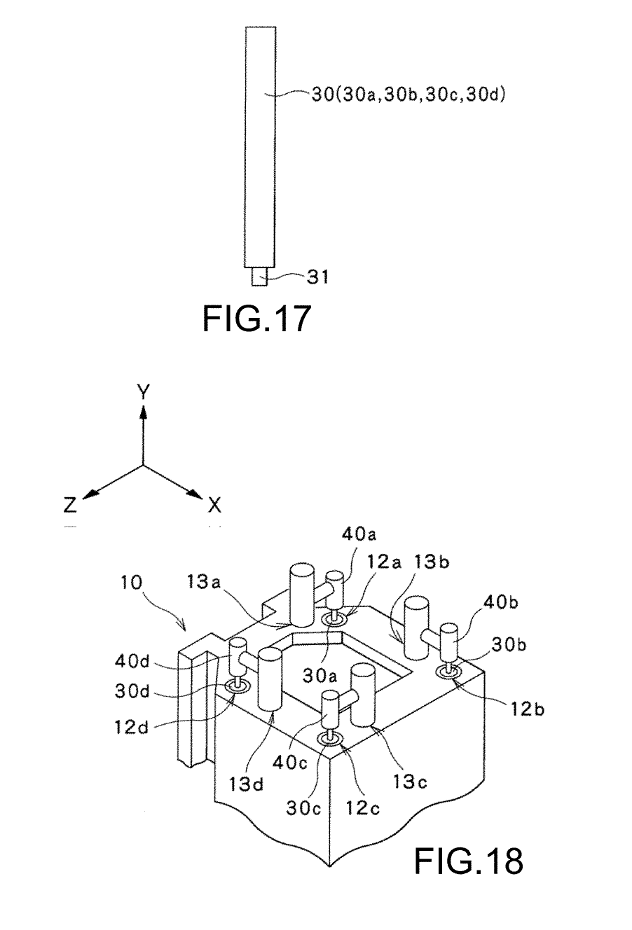

FIG. 16 is a schematic perspective view of the column 10 used in the machine tool 600 in FIG. 13. FIG. 17 is a schematic side view of a reference bar 30 used in the second embodiment of the present invention. As illustrated in FIG. 16, the column 10 of the present embodiment is formed with first to fourth through holes 12a, 12b, 12c, and 12d extending in the vertical direction with a diameter of 64 mm. In the present embodiment, the first to fourth through holes 12a, 12b, 12c, and 12d are included in the vicinity of corner portions (vertices of a rectangular on a cross section) of the column 10.

As illustrated in FIG. 16, the first to fourth through holes 12a, 12b, 12c, and 12d of the present embodiment are inserted with first to fourth reference bars 30a, 30b, 30c, and 30d, respectively. As illustrated in FIG. 17, the first to fourth reference bars 30a, 30b, 30c, and 30d of the present embodiment have a columnar shape with a diameter of 30 mm formed with a male screw portion 31 at a lower end portion thereof. The male screw portion 31 is screwed to a female screw portion included in the pedestal 14 of the column 10. In the above state, the first to fourth reference bars 30a, 30b, 30c, and 30d are inserted in sliding bearings of a ring shape provided to the first to fourth through holes 12a, 12b, 12c, and 12d of the column 10 and thereby supported and are disposed such that the first to fourth reference bars 30a, 30b, 30c, and 30d do not interfere with elongation or shrinkage of the column 10 in the vertical direction.

The first to fourth reference bars 30a, 30b, 30c, and 30d of the present embodiment have a linear expansion coefficient smaller than that of the column 10 in the vertical direction. Specifically, the first to fourth reference bars 30a, 30b, 30c, and 30d of the present embodiment have a linear expansion coefficient of 0.29×10⁻⁶/° C. in the vertical direction at 30° C. to 100° C.

FIG. 18 is a partial schematic perspective view illustrating details of an upper portion of the column 10 in FIG. 13. As illustrated in FIG. 18, the first to fourth measurement target zones 13a, 13b, 13c, and 13d in the upper portion of the column 10 are installed with the first to fourth displacement sensors 40a, 40b, 40c, and 40d of a contact type, respectively, and distances between the first to fourth measurement target zones 13a, 13b, 13c, and 13d and the measurement target zones of the first to fourth reference bars 30a, 30b, 30c, and 30d, respectively, in the vertical direction are measured. The displacement sensors 40a, 40b, 40c, and 40d are illustrated while enlarged in FIG. 18.

FIG. 19 is schematic block diagram of a control device 200 of a third embodiment of the present invention. An output signal from the displacement sensors 40a, 40b, 40c, and 40d is transmitted to the control device 200 in the present embodiment. As illustrated in FIG. 19, the control device 200 includes a posture change evaluation unit 210 that evaluates a posture change of the column 10 based on measurement results by the first to fourth displacement sensors 40a, 40b, 40c, and 40d and a correction data generation unit 220 that generates data for correcting displacement of a tip of a spindle 22 based on the evaluation result by the posture change evaluation unit 210. The correction data generation unit 220 is connected to a control unit 23 that controls a position of the tip of the spindle 22 and thus the generated correction data is output to the control unit 23.

Next, operations of the machine tool 600 of the present embodiment will be described.

First, a desired processing tool (e.g. milling cutter) is attached to the tip of the spindle 22.

Next, a user installs a workpiece W to be processed at a predetermined position and inputs desired processing data to the control device 200. The processing machine 100 is controlled based on the processing data. Next, the spindle head 20 is transferred in the vertical direction to a desired position via the ball screw 16 based on the processing data. A ram 21 supporting the spindle 22 is then fed in the horizontal direction toward the workpiece W.

Thereafter, rotation of the spindle 22 is initiated by a spindle driving mechanism in the spindle head 20 and supply of cutting fluid toward a tip of the processing tool is initiated, thereby initiating processing of the workpiece W.

In the present embodiment, the first to fourth displacement sensors 40a, 40b, 40c, and 40d measure distances between the measurement target zones on the top surface of the first to fourth reference bars 30a, 30b, 30c, and 30d and the first to fourth measurement target zones 13a, 13b, 13c, and 13d on the top surface of the column 10, respectively, in the vertical direction before initiation of processing of the workpiece W.

Next, the posture change evaluation unit 210 compares the measured respective distances to the respective reference distances of the first to fourth measurement target zones 13a, 13b, 13c, and 13d stored in the posture change evaluation unit 210 and a posture change of the column 10 is evaluated according to the measurement principles described above. Note that the respective reference distances are measured in advance under a predetermined reference condition for example upon accuracy adjustment of the processing machine and are restored in the posture change evaluation unit 210.

In the present embodiment, inclination of the column 10 can be evaluated for two directions of the Z axis direction (spindle direction) and the X axis direction (direction perpendicular to the Z axis direction on a horizontal plane) based on the measurement results at the four portions. That is, the posture change evaluation unit 210 evaluates displacement of the first to fourth measurement target zones 13a, 13b, 13c, and 13d of the column 10 in the vertical direction (a′−a (=Δa), b′−b (=Δb), c′−c (=Δc), and d′−d (=Δd)). The posture change evaluation unit 210 then, for example, evaluates differences between average values of two values of the displacement (Δc+Δb)/2−(Δd+Δa)/2 (=δx) and (Δc+Δd)/2−(Δb+Δa)/2 (=δz). Substituting each of δx and δz in δ of the above mathematical formula (1) and thereby θ is evaluated for each of the X axis direction and the Z axis direction. Then the posture change evaluation unit 210 approximates inclination of the column 10 by a linear line based on the θ and thereby evaluates a posture change of the column 10 in the X axis direction and the Z axis direction.

The evaluation result by the posture change evaluation unit 210 is transmitted to the correction data generation unit 220 and the correction data generation unit 220 generates correction data for correcting displacement of the tip of the spindle 22. Various known algorithms may be employed for generation itself of the correction data.

The correction data is transmitted to the control unit 23 that controls (corrects) a position of the tip of the spindle 22.

The control unit 23 then controls (corrects) a position of the tip of the spindle 22 according to the transmitted correction data. Various known algorithms may be employed as for specific contents of control by the control unit 23.

According to the present embodiment as described above, directly measuring the distances in the vertical direction between the first to fourth measurement target zones 13a, 13b, 13c, and 13d of the column 10 and the measurement target zones of the first to fourth reference bars 30a, 30b, 30c, and 30d, respectively, by the first to fourth displacement sensors 40a, 40b, 40c, and 40d based on differences in linear expansion coefficients in the vertical direction between the column 10 and the first to fourth reference bars 30a, 30b, 30c, and 30d allows for measuring thermal displacement of the column 10 at a low cost with a high accuracy. This allows for measuring a posture change of the column 10 at a low cost with a high accuracy, thereby allowing for providing the machine tool 600 capable of correcting displacement of the tip of the spindle 22 attributable to the posture change and implementing precise processing of the workpiece W.

According to the present embodiment, especially, directly measuring the distances in the vertical direction between the first to fourth measurement target zones 13a, 13b, 13c, and 13d of the column 10 and the measurement target zones of the first to fourth reference bars 30a, 30b, 30c, and 30d, respectively, by the first to fourth displacement sensors 40a, 40b, 40c, and 40d based on differences in linear expansion coefficients in the vertical direction between column 10 and the first to fourth reference bars 30a, 30b, 30c, and 30d allows for measuring thermal displacement of the column 10 at a low cost with an even higher accuracy. This allows for measuring a posture change of the column 10 at a low cost with an even higher accuracy, thereby allowing for providing the machine tool 600 capable of correcting displacement of the tip of the spindle 22 attributable to the posture change and implementing precise processing of the workpiece W.

The first to fourth displacement sensors 40a, 40b, 40c, and 40d measure distances between the measurement target zones of the first to fourth reference bars 30a, 30b, 30c, and 30d and the first to fourth measurement target zones 13a, 13b, 13c, and 13d of the column 10, respectively, in the vertical direction before initiation of processing of the workpiece W. The posture change evaluation unit 210 evaluates a posture change of the column 10 by comparing the measured respective distances to the respective reference distances of the first to fourth measurement target zones 13a, 13b, 13c, and 13d stored in the posture change evaluation unit 210.

The first to fourth reference bars 30a, 30b, 30c, and 30d have a linear expansion coefficient of 0.29×10⁻⁶/° C. in the vertical direction at 30° C. to 100° C. Therefore, thermal displacement in the vertical direction rarely occurs in the first to fourth reference bars 30a, 30b, 30c, and 30d and thus the distances between the measurement target zones of the respective reference bars 30a, 30b, 30c, and 30d and the first to fourth measurement target zones 13a, 13b, 13c, and 13d of the column 10, respectively, in the vertical direction can be handled as thermal displacement in the vertical direction in the first to fourth measurement target zones 13a, 13b, 13c, and 13d of the column 10.

In the present embodiment, the column 10 is formed with first to fourth through holes 12a, 12b, 12c, and 12d extending in the vertical direction and the first to fourth reference bars 30a, 30b, 30c, and 30d are supported by sliding bearings provided to the first to fourth through holes 12a, 12b, 12c, and 12d. In this case, the first to fourth reference bars 30a, 30b, 30c, and 30d can be disposed in such a manner not interfering with elongation or shrinkage of the column 10 in the vertical direction.

In the present embodiment, the four displacement sensors 40a, 40b, 40c, and 40d of a contact type supported at the first to fourth measurement target zones 13a, 13b, 13c, and 13d of the column 10 are employed as the measurement means. Therefore, distances between the measurement target zones of the first to fourth reference bars 30a, 30b, 30c, and 30d and the first to fourth measurement target zones 13a, 13b, 13c, and 13d of the column 10 in the vertical direction can be easily measured with a high accuracy.

Next, a third embodiment of the present invention will be described with reference to FIG. 20. FIG. 20 is a partial schematic perspective view illustrating details of an upper portion of a column 510 in a machine tool 700 of the third embodiment of the present invention. In the present embodiment, first to third through holes 512a, 512b, and 512c extending in the vertical direction are formed on three corner portions of the column 510 as illustrated in FIG. 20. The respective through holes 512a, 512b, and 512c are inserted with first to third reference bars 530a, 530b, and 530c, respectively. In the upper portion of the column 510, first to third measurement target zones 513a, 513b, and 513c are associated with the first to third reference bars 530a, 530b, and 530c.

Also in the present embodiment, the respective measurement target zones 513a, 513b, and 513c are installed with first to third displacement sensors 540a, 540b, and 540c of a contact type similar to those of the second embodiment, respectively, and distances between the measurement target zones of the respective reference bars 530a, 530b, and 530c and the respective measurement target zones 513a, 513b, and 513c of the column 510, respectively, in the vertical direction are measured. The other configurations are the same as those of the second embodiment.

Also in the present embodiment, inclination of the column 510 is evaluated for the two directions of the X axis direction and the Z axis direction according to the measurement principles described above. That is, the posture change evaluation unit 210 evaluates displacement of the respective measurement target zones 513a, 513b, and 513c of the column 510 in the vertical direction (a′−a (=Δa), b′−b (=Δb), and c′−c (=Δc)). The posture change evaluation unit 210 then, for example, evaluates Δb−(Δa+Δc)/2 (=δx) and Δc−Δa (=δz). Substituting each of δx and δz in b of the above mathematical formula (1) and thereby θ is evaluated for each of the X axis direction and the Z axis direction. Then the posture change evaluation unit 210 approximates inclination of the column 510 by a linear line based on the θ and thereby evaluates a posture change of the column 510 in the X axis direction and Z axis direction.

Note that a combination of mathematical formulas of δx and δz where an evaluation accuracy of posture change of the column 510 is the maximum, for example Δb−(Δa+Δc)/2 (=δx) and Δc−(Δb+Δa)/2 (=δz′) may be specified from measurement values depending on the environment of a place where the machine tool is installed and the combination of the mathematical formulas may be employed.

Then the evaluation result by the posture change evaluation unit 210 is transmitted to the correction data generation unit 220 and correction of displacement of the spindle tip is performed in a similar manner to the second embodiment.

In FIG. 20, the through holes 512a, 512b, and 512c are included in the vicinity of three corner portions of the column 510 but are not limited thereto. At least one of the first to third through holes 512a, 512b, and 512c may be included at a middle point between adjacent two corner portions (for example, two of the first to third through holes 512a, 512b, and 512c may be included in the vicinity of two adjacent corner portions of the column 510 while the remaining one out of the through holes 512a, 512b, and 512c may be disposed at a middle point between the other two corner portions).

According to the present embodiment, the distances in the vertical direction between the first to third measurement target zones 513a, 513b, and 513c of the column 510 and the measurement target zones of the reference bars 530a, 530b, and 530c, respectively, are directly measured by the first to third displacement sensors 540a, 540b, and 540c based on differences in linear expansion coefficients in the vertical direction between the column 510 and the first to third reference bars 530a, 530b, and 530c. This allows for measuring thermal displacement of the column 510 at a low cost with an even higher accuracy. This allows for measuring a posture change of the column 510 at a low cost with an even higher accuracy, thereby allowing for providing the machine tool capable of correcting displacement of the spindle tip attributable to the posture change and implementing precise processing of the workpiece W.

Note that in the second and the third embodiments, the reference bars 30 and 530 are not necessarily formed by a single member but may be configured by a plurality of reference bar components coupled to each other. In this case, each of the reference bar components is formed with an engaging portion (e.g. male screw portion) at a lower end portion thereof and an engaged portion (e.g. female screw portion) that is engaged with the engaging portion is formed at an upper end portion thereof.

The displacement sensors 40 and 540 are not limited to a contact type and may be a contactless type (for example an optical type). Therefore, distances between the measurement target zones of the reference bars 30 and 530 and the measurement target zones 13 and 513 of the columns 10 and 510, respectively, in the vertical direction can be easily measured with a high accuracy.

In the respective embodiments the displacement sensors 40 and 540 are installed at the measurement target zones 13 and 513 of the columns 10 and 510, respectively, but may be installed at measurement target zones of the reference bars 30 and 530 contrary to this.

In the respective embodiments the reference bars 30 and 530 are columnar members but may have other shapes such as a rectangular columnar shape or a polygonal columnar shape.

Moreover, a material is not limited to a low thermal expansion material and may be other materials as long as the material can be processed into a rod shape.

Also in this case, measuring distances between the respective measurement target zones 13 and 513 of the columns 10 and 510 and the reference bars 30 and 530 allows for evaluating a posture change of the columns 10 and 510.

Alternatively, the displacement sensors 40 and 540 may sequentially measure distances in the vertical direction between the measurement target zones of the reference bars 30 and 530 and the measurement target zones 13 and 513 of the columns 10 and 510, respectively, and the posture change evaluation unit may sequentially evaluate a posture change of the columns 10 and 510 by sequentially comparing the distances in the vertical direction. In this case, displacement of the spindle tip attributable to a posture change of the columns 10 and 510 can be corrected more smoothly.

Note that in the descriptions above, the cases where the two, three, or four measurement target zones in the upper portion of the column are associated with the reference bars are exemplified; however, five or more measurement target zones may be included. That is, for example, a machine tool may include five measurement target zones apart from each other by a predetermined distance on a top surface of a column associated with measurement target zones of reference bars. A measurement means measures distances in the vertical direction between the measurement target zones of the reference bars and the five measurement target zones of the column and a posture change evaluation unit evaluates a posture change of the column based on the measurement results of the five distances in the vertical direction by the measurement means. Also in this case, correction of displacement of the spindle tip can be preferably performed similarly to the respective embodiments described above.

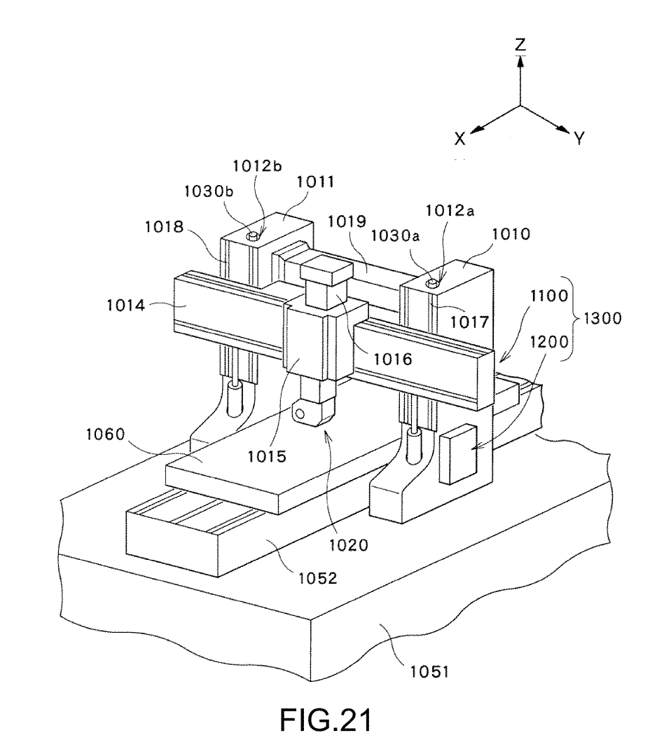

Next, a fourth embodiment of the present invention will be described in detail with reference to FIGS. 21 to 27.

FIG. 21 is a schematic perspective view of a machine tool 1300 of a fourth embodiment of the present invention. As illustrated in FIG. 21, the machine tool 1300 of the present embodiment includes a processing machine 1100 and a control device 1200 that controls the processing machine 1100.

The processing machine 1100 of the present embodiment is a machining center of a double column type and includes: a foundation 1051; a first column 1010 and a second column 1011 of a rectangular columnar shape fixed on the foundation 1051 at a predetermined interval in a vertically standing manner; a cross rail 1014 that is supported by the first column 1010 and the second column 1011 by an appropriate supporting mechanism and is extending in the horizontal direction; and a spindle head 1020 that is supported by the cross rail 1014 and supports a vertical spindle for attaching a tool thereto as illustrated in FIG. 21. Upper portions of the first column 1010 and the second column 1011 of the present embodiment are coupled to each other by a brace 1019 parallel to the cross rail 1014. Note that a vertical spindle refers to a spindle having a vertical rotation axis.

As illustrated in FIG. 21, the machine tool 1300 of the present embodiment includes a foundation 1051 and a bed 1052 fixed over the foundation 1051 via leveling blocks 1053. The foundation 1051 and the bed 1052 are installed for example in the following manner similarly to the first embodiment. That is, a primary hole is provided on a floor surface at a position where the machine tool 1300 of the present embodiment is installed. Concrete is then poured into the primary hole while a secondary hole is secured by a wood material or the like, thereby laying the foundation 1051. Thereafter foundation bolts and the leveling blocks 1053 are attached to the bed 1052 and then the bed 1052 is supported at a plurality of points such that the foundation bolt enters the secondary hole. The bed 1052 is provisionally mounted on the foundation 1051 by a jack (provisional centering tool) or the like. The bed 1052 is then provisionally adjusted to be horizontal and concrete (and curing agent) is poured into the secondary hole, which completes construction of the foundation. When the concrete in the secondary hole is cured, the jack or the like is removed and the leveling blocks 1053 are adjusted, thereby securing structures (bed 1052 and respective columns 1010 and 1011) to be horizontal. As apparent from the above, inclination of the bed 1052 of the present embodiment with respect to the foundation 1051 can be adjusted (corrected) by adjusting the leveling blocks 1053.

As illustrated in FIG. 21, the cross rail 1014 of the present embodiment includes guided portions (groove portions) in an area facing the first column 1010 and the second column 1011. The guided portions are engaged to guiding portions (rails) 1017 and 1018 integrally included on one side surface of the column 1010. The guiding portions 1017 and 1018 may be a known sliding guide or dynamic pressure guide. The cross rail 1014 of the present embodiment is driven in the vertical direction (Z axis direction in FIG. 21) by a known driving mechanism along the guiding portions 1017 and 1018. The cross rail 1014 of the present embodiment is provided with a saddle 1015 formed with a through hole in the vertical direction and a ram 1016 of a rectangular columnar shape that is supported in the through hole of the saddle 1015 and is slidable in the through hole in the vertical direction.

In the present embodiment, although not illustrated, a tip portion of the spindle can be attached with a desired processing tool in a detachable manner. The spindle of the present embodiment is capable of rotating about an axis at, for example, 5 to 10000 min-1 by a known driving mechanism included in the spindle head 1020 and also can be fed in the vertical direction by 900 mm at the maximum, for example, by the ram 1016 transferred (slid) by the driving mechanism included in the saddle 1015.

A mobile table 1060 whereon a workpiece is placed is further installed on the bed 1052. The table 1060 is movable in a longitudinal direction of the bed 1052 (X axis direction in FIG. 21) on a horizontal plane by an appropriate driving mechanism. Positioning of the spindle with respect to a workpiece in the X axis direction is performed by this movement. In the present embodiment, the cross rail 1014 supporting the spindle head 1020 is movable in the vertical direction along the column 1010. Positioning of the spindle with respect to the workpiece in the Z axis direction is performed by this movement. The saddle 1015 of the present embodiment is movable along a longitudinal direction of the cross rail 1014 (Y axis direction in FIG. 21) on the cross rail 1014 by an appropriate driving mechanism. Positioning of the spindle with respect to the workpiece in the Y axis direction is performed by this movement.

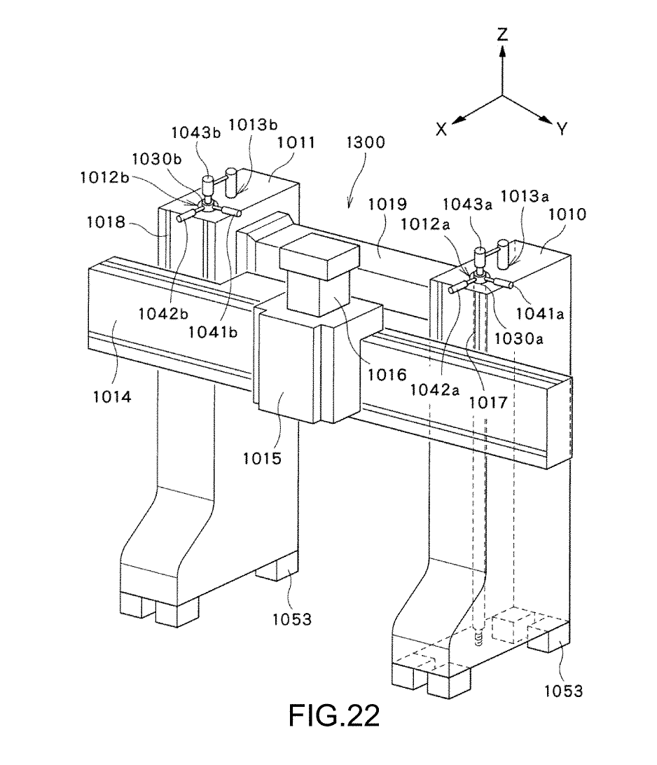

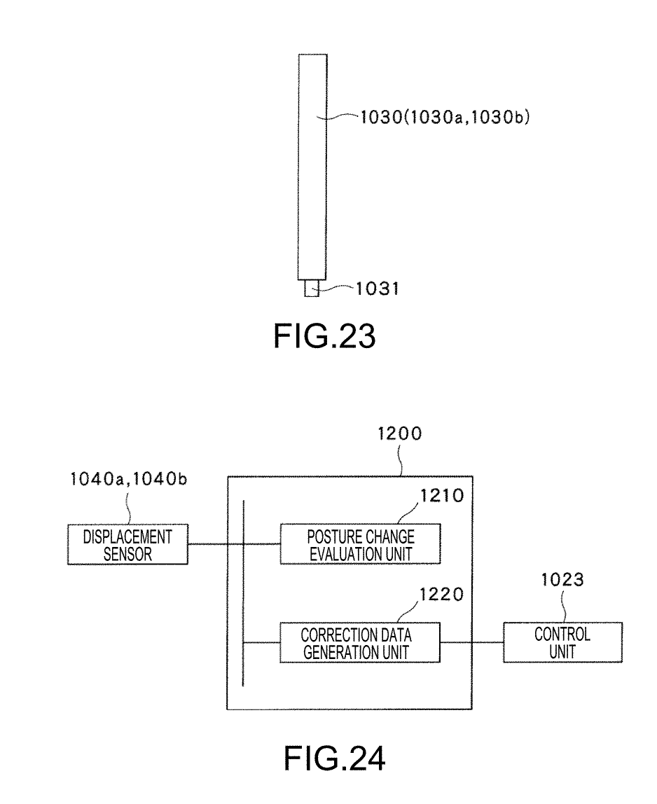

FIG. 22 is a partial schematic perspective view illustrating details of an upper portion of the machine tool 1300 and an inner part of the first column 1010 in FIG. 21. FIG. 23 is a schematic side view of a reference bar 1030 used in the machine tool 1300 in FIG. 21. As illustrated in FIG. 22, the first column 1010 of the present embodiment is formed with a first through hole 1012a in the vertical direction and the second column 1011 is formed with a second through hole 1012b in the vertical direction. In the present embodiment, respective through holes 1012a and 1012b are included in the vicinity of a side surface, facing the cross rail 1014, of the columns 1010 and 1011, respectively, at equal distances in a direction (X axis direction in FIG. 22) perpendicular to the axial direction (Z axis direction in FIG. 22) of the spindle 1020.

As illustrated in FIG. 22, the respective through holes 1012a and 1012b of the present embodiment are inserted with first and second reference bars 1030a and 1030b, respectively. As illustrated in FIG. 23, the first reference bar 1030a and the second reference bar 1030b of the present embodiment have a columnar shape formed with a male screw portion 1031 at a lower end portion thereof. The male screw portions 1031 are screwed to female screw portions provided to the respective columns 1010 and 1011, respectively. The respective columns 1010 and 1011 of the present embodiment are supported on leveling blocks 1053 in a fixed manner while the leveling blocks 1053 fixed to the foundation 1051 are adjusted such that the cross rail 1014 vertically moves via the guiding portions 1017 and 1018. In the present embodiment, the first reference bar 1030a and the second reference bar 1030b are screwed to lower portions of the respective columns 1010 and 1011 supported on the leveling blocks 1053 fixed to the foundation 1051 in such a manner not interfering with an inner peripheral surfaces of the first through hole 1012a and the second through hole 1012b upon normal use of the machine tool 1300. In other embodiments, the first reference bar 1030a and the second reference bar 1030b may be independently fixed to the foundation 1051 via blocks that are ensured to be horizontal.

The first reference bar 1030a and the second reference bar 1030b of the present embodiment have a linear expansion coefficient smaller than that of the first column 1010 and the second column 1011. The linear expansion coefficient at 30° C. to 100° C. is 0.29×10⁻⁶/° C.

Referring back to FIG. 22, upper portions of the first column 1010 and the second column 1011 of the present embodiment are provided with a first measurement target zone 1013a and a second measurement target zone 1013b, respectively. The first measurement target zone 1013a and the second measurement target zone 1013b are provided with a first displacement sensor 1040a and a second displacement sensor 1040b of a contact type. The first displacement sensor 1040a of the present embodiment includes a first Z axis displacement sensor 1041a that detects displacement or a distance in the vertical direction (Z axis direction in FIG. 22) and a first X axis displacement sensor 1042a and a first Y axis displacement sensor 1043a that detect displacement or distances in the two directions perpendicular to each other on a horizontal plane (X axis direction and Y axis direction in FIG. 22). Similarly, the second displacement sensor 1040b of the present embodiment includes a second Z axis displacement sensor 1041b that detects displacement or a distance in the Z axis direction and a second X axis displacement sensor 1042b and a second Y axis displacement sensor 1043b that detect displacement or distances in the two directions perpendicular to each other on a horizontal plane. Displacement or distances in the X, Y, and the Z axis directions between the first measurement target zone 1013a and the second measurement target zone 1013b and measurement target zones of the first reference bar 1030a and the second reference bar 1030b, respectively, are measured by the first displacement sensor 1040a and the second displacement sensor 1040b. The first displacement sensor 1040a and the second displacement sensor 1040b of the present embodiment employ a digital sensor of a contact type. The first displacement sensor 1040a and the second displacement sensor 1040b are illustrated while enlarged in FIG. 22.

FIG. 24 is a schematic block diagram of the control device 1200 used in the machine tool 1300 in FIG. 21. As illustrated in FIG. 24, an output signal from the first displacement sensor 1040a and the second displacement sensor 1040b is transmitted to the control device 1200 in the present embodiment. As illustrated in FIG. 24, the control device 1200 includes a posture change evaluation unit 1210 that evaluates a posture change of the first column 1010 and the second column 1011 based on the measurement results by the first displacement sensor 1040a and the second displacement sensor 1040b and a correction data generation unit 1220 that generates data for correcting displacement (positional shift) of the spindle tip based on the evaluation result by the posture change evaluation unit 1210. The correction data generation unit 1220 is connected to a control unit 1023 that controls a position of the spindle tip and thus the generated correction data is output to the control unit 1023.

In the present embodiment, distances in the vertical direction (Z axis direction in FIG. 22) and in the two directions perpendicular to each other on a horizontal plane (X axis direction and Y axis direction in FIG. 22) between the measurement target zones in the upper portions of the first reference bar 1030a and the second reference bar 1030b and the first measurement target zone 1013a and the second measurement target zone 1013b on a top surface of the first column 1010 and the second column 1011, respectively, are measured by the first displacement sensor 1040a and the second displacement sensor 1040b under a predetermined reference condition for example upon accuracy adjustment of the processing machine 1100. Specifically, distances ax and bx in the X axis direction between the measurement target zones in the upper portions of the first reference bar 1030a and the second reference bar 1030b and the first measurement target zone 1013a and the second measurement target zone 1013b on a top surface of the first column 1010 and the second column 1011, respectively, are measured by the first X axis displacement sensor 1042a and the second X axis displacement sensor 1042b and thereby forward inclination, backward inclination, and twisting of the spindle (saddle 1015/cross rail 1014) are confirmed. Distances ay and by in the Y axis direction between the measurement target zones in the upper portions of the first reference bar 1030a and the second reference bar 1030b and the first measurement target zone 1013a and the second measurement target zone 1013b on a top surface of the first column 1010 and the second column 1011, respectively, are measured by the first Y axis displacement sensor 1041a and the second Y axis displacement sensor 1041b and thereby leftward inclination and rightward inclination of the spindle (saddle 1015/cross rail 1014) are confirmed. Distances az and bz in the Z axis direction between the measurement target zones in the upper portions of the first reference bar 1030a and the second reference bar 1030b and the first measurement target zone 1013a and the second measurement target zone 1013b on the top surface of the first column 1010 and the second column 1011, respectively, are measured by the first Z axis displacement sensor 1043a and the second Z axis displacement sensor 1043b and thereby elongation or shrinkage of the column that directly influences the direction of elongation or shrinkage of the spindle (saddle 1015/cross rail 1014) is confirmed. The measured respective distances ax, ay, and az and bx, by, and bz are stored in the posture change evaluation unit 1210 in the control device 1200 as reference distances and thereby specific displacement as described above and a correction value therefor are calculated.

Next, operations of the machine tool 1300 of the present embodiment will be described.

First, a desired processing tool (e.g. milling cutter) is attached to the spindle tip. Next, a user installs a workpiece to be processed on the table 1060 and inputs desired processing data to the control device 1200. The processing machine 1100 is controlled based on the processing data. Next, the table 1060 mounted with the workpiece is transferred in the longitudinal direction (X axis direction in FIG. 21) of the bed 1052 based on the processing data and thereby positioning in the X axis direction is performed. The saddle 1015 supporting the spindle head 1020 via the ram 1016 is transferred in the longitudinal direction of the cross rail 1014 and thereby positioning in the Y axis direction is performed. Furthermore, the ram 1016 is fed in the vertical direction (Z axis direction in FIG. 21) with respect to the saddle 1015 and thereby positioning in the Z axis direction is performed.

Thereafter, rotation of the spindle is initiated by a spindle driving mechanism in the spindle head 1020 and supply of cutting fluid toward a tip of the processing tool is initiated, thereby initiating processing of the workpiece.

In the present embodiment, before initiation of processing of the workpiece, the first displacement sensor 1040a measures distances ax′, ay′, and az′ between the measurement target zones of the first reference bar 1030a and the first measurement target zone 1013a of the first column 1010 in the X, Y, and the Z axis directions and the second displacement sensor 1040b measures distances bx, by′, and bz′ between the measurement target zones of the second reference bar 1030b and the second measurement target zone 1013b of the second column 1011 in the X, Y, and the Z axis directions. The posture change evaluation unit 1210 in the control device 1200 then evaluates displacement of the first measurement target zone 1013a and the second measurement target zone 1013b relative to the reference distances in the X, Y, and the Z axis directions. That is, displacement of the first measurement target zone 1013a relative to each of the reference distances in the X, Y, and the Z axis directions is represented by ax′−ax (=Δax), ay′−ay (=Δay), and az′−az (=Δaz). Displacement of the second measurement target zone 1013b relative to each of the reference distances in the X, Y, and the Z axis directions is represented by bx′−bx (=Δbx), by′−by (=Δby), and bz′−bz (=Δbz).

The posture change evaluation unit 1210 evaluates undesired displacement δ of the spindle tip due to a posture change of the spindle head 1020 attributable to deformation of the first column 1010 and the second column 1011 for each of the X, Y, and the Z axis directions. Specifically, displacement δ is evaluated for each of the X, Y, and the Z axis directions based on a change in inclination between a linear line, connecting the first measurement target zone 1013a of the first column 1010 and the second measurement target zone 1013b of the second column 1011 without considering a posture change of the first column 1010 and the second column 1011, and the linear line considering a posture change of the first column 1010 and the second column 1011.

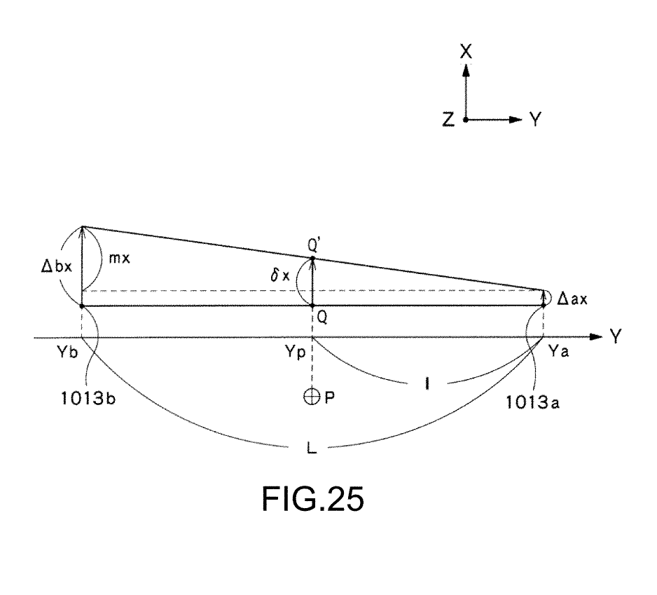

Regarding this evaluation, FIG. 25 illustrates a diagram for explaining displacement of the first measurement target zone 1013a and the second measurement target zone 1013b and the spindle tip upon deformation of the first column 1010 and the second column 1011. First, a posture change of the spindle head 1020 in the X axis direction will be examined. As illustrated in FIG. 25, when a Y coordinate of the second measurement target zone 1013b is denoted as Yb, a Y coordinate of the first measurement target zone 1013a is denoted as Ya, a linear distance from the first measurement target zone 1013a to the Y coordinate Yp of the nominal spindle tip P without considering a posture change of the first column 1010 and the second column 1011 is denoted as I, a distance between the first measurement target zone 1013a of the first column 1010 and the second measurement target zone 1013b of the second column 1011 without considering a posture change of the first column 1010 and the second column 1011 is denoted as L, inclination of the linear line on an X-Y plane with consideration to a posture change of the first column 1010 and the second column 1011 is denoted as mx, and a distance (displacement) between an actual spindle tip and the nominal spindle tip P with consideration to a posture change of the first column 1010 and the second column 1011 is denoted as δ, an X axis direction component δx of displacement δ is equivalent to a linear distance between Q and Q′ in FIG. 25 and is represented by the following mathematical formula.

δx=Δax+mxl (where mx=(Δbx−Δax)/L) [Mathematical Formula 8]

The result above examined is similar to the case of evaluating a posture change of the spindle head 1020 in the Z axis direction. That is, a component δz of displacement δ in the Z axis direction is represented by the following mathematical formula.

δz=Δaz+mzl (where mz=(Δbz−Δaz)/L) [Mathematical Formula 9]

Evaluation in the Y axis direction can be also performed in a similar manner.

δy=Δay+myl (where my=(Δby −Δay)/L) [Mathematical Formula 10]

In the above respective mathematical formulas, δ is calculated while decomposed into orthogonal three axes. Note that the respective columns 1010 and 1011 are coupled to each other by the brace 1019 and the cross rail 1014 and thus, physically, a posture change (leftward or rightward inclination) in the Y axis direction cannot occur independently in the column 1010 or 1011. Therefore, the machine tool 1300 of the present embodiment is preferably provided with a monitoring system that gives an alarm when an abnormal posture change occurs such as a change of a certain level or more in a distance between the columns 1010 and 1011 or a phenomenon occurs where the column 1010 or 1011 independently falls in opposite directions (directions approaching each other or directions away from each other). However, there are cases where minute displacement occurs where the columns 1010 and 1011 are seemingly independently inclined in opposite directions and thus it is desirable to regard a certain amount or less as an error.

The evaluation result by the posture change evaluation unit 1210 is transmitted to the correction data generation unit 1220 and the correction data generation unit 1220 generates correction data for correcting displacement of the spindle tip. Various known algorithms may be employed for generation itself of the correction data. The generated correction data is transmitted to the control unit 1023 that controls (corrects) a position of the spindle tip. The control unit 1023 then controls (corrects) a position of the spindle tip according to the received correction data. Various known algorithms may be employed as for specific contents of control by the control unit 1023.

According to the present embodiment, directly measuring distances between the measurement target zones of the first reference bar 1030a and the second reference bar 1030b and the first measurement target zone 1013a and the second measurement target zone 1013b of the first column 1010 and the second column 1011, respectively, in the vertical direction (Z axis direction) and two directions perpendicular to each other on a horizontal plane (X axis direction and Y axis direction) by the first displacement sensor 1040a and the second displacement sensor 1040b allows for measuring thermal displacement of the first column 1010 and the second column 1011 at a low cost with a high accuracy. This allows for measuring posture changes of the first column 1010 and the second column 1011 at a low cost with a high accuracy, thereby allowing for providing the machine tool 1300 capable of correcting displacement of a spindle tip attributable to the posture change and implementing precise processing of a workpiece.

The posture change evaluation unit 1210 of the present embodiment evaluates a change in inclination of the linear line connecting the first measurement target zone 1013a of the first column 1010 and the second measurement target zone 1013b of the second column 1011 based on each of the measurement results of distance by the first displacement sensor 1040a and the second displacement sensor 1040b and thereby evaluates a posture change of the spindle head 1020. Due to this, a calculation process is simple and thus posture changes of the first column 1010 and the second column 1011 can be promptly evaluated.

Under a predetermined reference condition, the first displacement sensor 1040a measures, as reference distance, a distance between the measurement target zone of the first reference bar 1030a and the first measurement target zone 1013a of the first column 1010 in each of the vertical direction and two directions perpendicular to each other on a horizontal plane and the second displacement sensor 1040b measures, as a reference distance, a distance between the measurement target zone of the second reference bar 1030b and the second measurement target zone 1013b of the second column 1011 in each of the vertical direction and the two directions perpendicular to each other on the horizontal plane, and the posture change evaluation unit 1210 evaluates a posture change of the spindle head 1020 by comparing the reference distance and each of distances measured by the first displacement sensor 1040a and the second displacement sensor 1040b. Therefore, it is easy to evaluate displacement in each axis direction.

The first reference bar 1030a and the second reference bar 1030b have a linear expansion coefficient of 0.29×10⁻⁶/° C. at 30° C. to 100° C. Therefore, thermal displacement rarely occurs in the first reference bar 1030a and the second reference bar 1030b and thus the distances between the measurement target zones of the first reference bar 1030a and the second reference bar 1030b and the first measurement target zone 1013a and the second measurement target zone 1013b of the first column 1010 and the second column 1011, respectively, in the X, Y, and the Z axis directions can be handled as thermal displacement in the first measurement target zone 1013a and the second measurement target zone 1013b of the first column 1010 and the second column 1011.

In the present embodiment, the first displacement sensor 1040a and a second displacement sensor 1040b of a contact type supported at the first measurement target zone 1013a and the second measurement target zone 1013b of the first column 1010 and the second column 1011 are employed. Therefore, distances between the measurement target zones of the first reference bar 1030a and the second reference bar 1030b and the first measurement target zone 1013a and the second measurement target zone 1013b of the first column 1010 and the second column 1011, respectively, in the X, Y, and the Z axis directions can be easily measured with a high accuracy.

Note that in the present embodiment, the first and the second reference bars 1030a and 1030b are not necessarily formed by a single member but may be configured by a plurality of reference bar components coupled to each other. In this case, each of the reference bar components is formed with an engaging portion (e.g. male screw portion) at a lower end portion thereof and an engaged portion (e.g. female screw portion) that is engaged with the engaging portion is formed at an upper end portion thereof.

The first displacement sensor 1040a and the second displacement sensor 1040b are not limited to a contact type and may be a contactless type (for example an optical type). Also in this case, the distances between the measurement target zones of the first reference bar 1030a and the second reference bar 1030b and the first measurement target zone 1013a and the second measurement target zone 1013b of the first column 1010 and the second column 1011, respectively, in the X, Y, and the Z axis directions can be easily measured with a high accuracy.

In the respective embodiments the first and the second displacement sensors 1040a and 1040b are installed at the first and the second measurement target zones 1013a and 1013b of the first column 1010 and the second column 1011, respectively, but may be installed at measurement target zones of the first and the second reference bars 1030a and 1030b contrary to this.

In the present embodiment the first and the second reference bars 1030a and 1030b are columnar members but may have other shapes such as a rectangular columnar shape or a polygonal columnar shape. Moreover, a material is not limited to a low thermal expansion material and may be other materials as long as the material can be processed into a rod shape. Also in this case, measuring distances between the first and the second measurement target zones 1013a and 1013b of the first column 1010 and the second column 1011 and the first reference bar 1030a and the second reference bar 1030b allows for evaluating a posture change of the first column 1010 and the second column 1011.

Alternatively, the first displacement sensor 1040a and the second displacement sensor 1040b may sequentially measure distances between the measurement target zones of the first reference bar 1030a and the second reference bar 1030b and the first and the second measurement target zones 1013a and 1013b of the first column 1010 and the second column 1011, respectively, in each of the X, Y, and the Z axis directions and the posture change evaluation unit 1210 may sequentially evaluate a posture change of the first column 1010 and the second column 1011 by sequentially comparing the distances. In this case, displacement of the spindle tip attributable to a posture change of the first column 1010 and the second column 1011 can be corrected more smoothly.

Note that in the present embodiment the case where a pair of measurement target zones of the reference bar and on the column associated with this reference bar is provided to each of the columns, in total two pairs, is described; however, two or more pairs may be provided to the respective columns. That is, for example, a machine tool may include two measurement target zones apart from each other by a predetermined distance on a top surface of each of columns associated with a measurement target zone of a reference bar, that is, four measurement target zones in total may be associated with two columns. A measurement means may measure distances between the measurement target zone of the reference bar and the two measurement target zones of the respective columns in the X, Y, and the Z axis directions and a posture change evaluation unit may evaluate a posture change of the column based on the four measurement results in total by the measurement means. Also in this case, correction of displacement of the spindle tip can be preferably performed similarly to the respective embodiments described above.

Alternatively, in the present embodiment, the first and the second measurement target zones 1013a and 1013b are provided with the first displacement sensor 1040a and the second displacement sensor 1040b, respectively, that measure displacement in each of the X, Y, and the Z axis directions; however, since physically, a posture change (leftward or rightward inclination) in the Y axis direction cannot occur independently in the column 1010 or 1011, for example the second Y axis displacement sensor 1043b of the second displacement sensor 1040b may be omitted and a posture change in the Y axis direction may be measured only by the first Y axis displacement sensor 1043a of the first displacement sensor 1040a. In this case, component δy of displacement δ in the Y axis direction is represented by the following mathematical formula. Such substitution by one sensor may be applied similarly in a variation described later.

δy=Δay [Mathematical Formula 11]

In the present embodiment, the spindle tip exists between two reference bars as illustrated in FIG. 25; however, a machine tool may include a spindle tip that does not exist between two reference bars but may include a positional relation where one reference bar exists between the spindle tip and the other reference bar. In this case, it is only required to assume that the spindle tip exists on an extended line from a line connecting the first measurement target zone 1013a and the second measurement target zone 1013b in FIG. 25. The correction calculation of displacement of the spindle tip based on FIG. 25 is merely an example and thus displacement of the spindle tip may be evaluated by another method. For example, the above may be substituted by another similar mathematical formula derived by a measurement value of the displacement sensor and measurement data of displacement of the spindle tip acquired in advance in a previous test.

Note that the machine tool 1300 of the present embodiment is described by an example of the machining center of a double column type having two columns 1010 and 1011 and thereby explained; however, the machine tool may include any number of columns as long as the machine tool includes a spindle that stands vertically. For example in a machine tool having a single column fixed to a bed, installing a plurality of pairs (for example two pairs along the Y axis direction) of reference bar and displacement sensor to the single column allows for evaluating displacement of the spindle tip based on the calculation formulas described above.

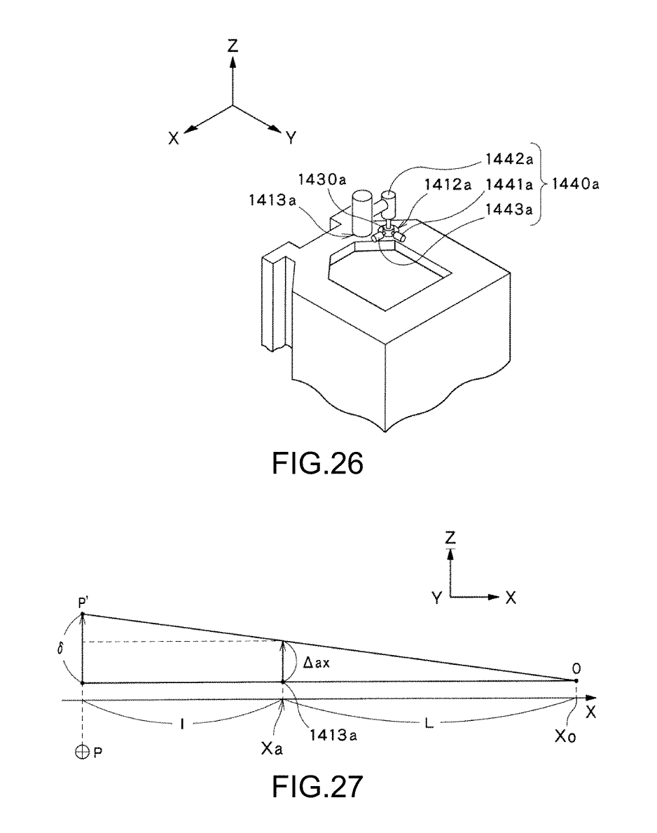

Alternatively, displacement of the spindle tip can be evaluated by installing a pair of reference bar and displacement sensor to a single column. An exemplary method for evaluating displacement of a spindle tip of this exemplary variation will be described with reference to FIGS. 26 and 27.

FIG. 26 is a partial schematic perspective view illustrating details of an upper portion of a column 1410 used in the present exemplary variation. FIG. 27 is a diagram for explaining displacement δ of a measurement target zone 1413a and a spindle tip upon deformation of the column 1410 in FIG. 26.

The column 1410 of the present variation is formed with a through hole 1412a in the vertical direction (Z axis direction in FIG. 26) only at a corner portion closest to a spindle head and a reference bar 1430a is inserted in the through hole 1412a. On a top surface of the column 1410, a measurement target zone 1413a is associated with the reference bar 1430a. The measurement target zone 1413a is installed with a displacement sensor 1440a of a contact type and a distance between a measurement target zone of the reference bar 1430a and the measurement target zone 1413a of the column 1410 in each of the vertical direction and two directions perpendicular to each other on a horizontal plane (X axis direction and Y axis direction in FIG. 26) is measured. Specifically, the displacement sensor 1440a of the present embodiment also includes a Z axis displacement sensor 1442a that detects displacement or a distance in the vertical direction and an X axis displacement sensor 1443a and a Y axis displacement sensor 1441a that detect displacement or distances in two directions perpendicular to each other on a horizontal plane. The displacement sensor 1440a measures displacement or a distance between the measurement target zone 1413a and the measurement target zone of the reference bar 1430a in each of the X, Y, and the Z axis directions.

For example upon accuracy adjustment of the processing machine, the displacement sensor 1440a measures in advance distances ax, ay, and az between the measurement target zone in the upper portion of the reference bar 1430a and the measurement target zone 1413a on the top surface of the column 1410 in each of the X, Y, and the Z axis directions under a predetermined reference condition. The respective distances ax, ay, and az are stored in a posture change evaluation unit in the control device as reference distances. The posture change evaluation unit also prestores a reference coordinate (coordinate of point O in FIG. 27) which is positioned on the top surface of the column 1410 and is different from the measurement target zone 1413a. As described later, a posture change of the spindle head 1020 is evaluated based on displacement of the measurement target zone 1413a with respect to this reference coordinate. The reference coordinate is set such that a linear line connecting the reference coordinate and the measurement target zone 1413a is parallel to the X axis.

Upon evaluation of displacement of the spindle tip, the displacement sensor 1440a measures distances ax′, ay, and az′ between the measurement target zone of the reference bar 1430a and the measurement target zone 1413a of the column 1410 in each of the X, Y, and the Z axis directions before initiation of processing of a workpiece also in the present variation. The posture change evaluation unit in the control device then evaluates displacement of the measurement target zone 1413a of the column 1410 with respect to the reference distance in each of the X, Y, and the Z axis directions (ax′−ax (=Δax), ay′−ay (=Δay), and az′−az (=Δaz)).

Based on the above evaluation results, the posture change evaluation unit evaluates a posture change of the column 1410. Regarding this evaluation, FIG. 27 illustrates a diagram for explaining displacement of the measurement target zone 1413a and the spindle tip upon deformation of the column 1410 in FIG. 26. First, a posture change of the spindle head 1020 in the X axis direction will be examined. As illustrated in FIG. 27, when an X coordinate of the point O is denoted as XO, an X coordinate of the measurement target zone 1413a is denoted as Xa, a distance from the measurement target zone 1413a to the nominal spindle tip P without considering a posture change of the column 1410 is denoted as I, a linear distance connecting the measurement target zone 1413a and the reference coordinate without considering a posture change of the column 1410 is denoted as L, and a distance (displacement) between an actual spindle tip P′ and the nominal spindle tip P with consideration to a posture change of the column 1410 is denoted as δ, an X axis direction component δx of displacement δ is represented by the following mathematical formula.

δx=Δax+mxl (where mx=Δax/L) [Mathematical Formula 12]

The result above examined is similar to the case of evaluating a posture change of the spindle head 1020 in the Z axis direction. That is, a component δz of displacement δ in the Z axis direction is represented by the following mathematical formula.

δz=Δaz+mzl (where mz=Δaz/L) [Mathematical Formula 13]

Meanwhile, as for the Y axis direction, a posture change of the spindle head 1020 is evaluated while displacement Δay occurring in the measurement target zone 1413a is regarded as also occurring at point O. This is because both of the measurement target zone 1413a and point O are on the column 1410 and thus a distance between the measurement target zone 1413a and point O in the Y axis direction is conserved. That is, a component δy of displacement δ in the Y axis direction is represented by the following mathematical formula.

δy=Δay [Mathematical Formula 14]

Similarly to the first embodiment, the evaluation result by the posture change evaluation unit 1210 is transmitted to the correction data generation unit 1220 and the correction data generation unit 1220 generates correction data for correcting displacement of the spindle tip. The generated correction data is transmitted to the control unit 1023 that controls (corrects) a position of the spindle tip. The control unit 1023 then controls (corrects) a position of the spindle tip according to the received correction data.

According to such an exemplary variation, directly measuring distances between the measurement target zone of the reference bar 1430a and the measurement target zone 1413a of the column 1410 in the vertical direction and two directions perpendicular to each other on a horizontal plane by the displacement sensor 1440a allows for measuring thermal displacement of the column 1410 at a low cost with a high accuracy. This allows for measuring a posture change of the column 1410 at a low cost with a high accuracy, thereby allowing for providing a machine tool capable of correcting displacement of a spindle tip attributable to the posture change and implementing precise processing of the workpiece W.

Note that descriptions are given assuming that the columns 1010, 1011, and 1410 are fixed on a foundation 1051 in the descriptions of the present embodiment or the two variations described above; however, the machine tool may be of a type where the columns 1010, 1011, and 1410 move on a foundation 1051. In this case, a guide member (e.g. bearing) that limits displacement of the reference bar in the horizontal direction may be provided in the through hole included in the column and displacement of the spindle tip only in the Z axis direction can be thereby evaluated.

When a machine tool includes two movable columns, each of the columns may be installed with a pair of reference bar and displacement sensor or may be installed with a plurality of pairs of reference bars and displacement sensors. In either case, displacement of a spindle tip can be evaluated based on the calculation formulas described in the present embodiment. Alternatively, displacement of a spindle tip may be evaluated based on another similar formula derived by a measurement value of the displacement sensor and measurement data of displacement in a test.

Also when a machine tool includes a single movable column, the column may be installed with a pair of reference bar and displacement sensor or may be installed with a plurality of pairs of reference bars and displacement sensors. Also in these cases, displacement of a spindle tip can be evaluated based on the calculation formulas described in the present embodiment and the aforementioned exemplary variations. Alternatively, displacement of a spindle tip may be evaluated based on another similar formula derived by a measurement value of the displacement sensor and measurement data of displacement in a test.

1. A machine tool, comprising:
a column that is disposed in a vertically standing manner and has a predetermined linear expansion coefficient;
a spindle head that is supported by the column and supports a horizontal spindle for attaching a tool thereto; and
a reference bar that is disposed separately from the column and has a linear expansion coefficient that is different from the linear expansion coefficient of the column,
wherein the column has a column-side measurement target zone,
the reference bar has a reference bar-side measurement target zone, and
a measurement means measures a distance between the column-side measurement target zone and the reference bar-side measurement target zone.

2. The machine tool according to claim 1, further comprising:
a posture change evaluation unit that evaluates a posture change of the spindle head based on the measurement result of the distance by the measurement means; and
a control unit that controls a position of a tip of the spindle based on the evaluation result by the posture change evaluation unit.

3. The machine tool according to claim 2,
wherein the posture change evaluation unit stores a predetermined reference distance between the reference bar-side measurement target zone and the column-side measurement target zone in each of a vertical direction and two directions perpendicular to each other on a horizontal plane, and
the posture change evaluation unit evaluates a posture change of the spindle head by comparing the reference distance and the distance measured by the measurement means.

4. The machine tool according to claim 2,
wherein the measurement means measures, as a reference distance, a distance between the reference bar-side measurement target zone and the column-side measurement target zone in each of a vertical direction and two directions perpendicular to each other on a horizontal plane under a predetermined reference condition, and
the posture change evaluation unit evaluates a posture change of the spindle head by comparing the reference distance and the distance measured by the measurement means.

5. The machine tool according to claim 2,
wherein the measurement means sequentially measures a distance between the reference bar-side measurement target zone and the column-side measurement target zone in each of a vertical direction and two directions perpendicular to each other on a horizontal plane, and
the posture change evaluation unit sequentially evaluates a posture change of the spindle head by sequentially comparing the distances measured by the measurement means.

6. The machine tool according to claim 2,
wherein a first column-side measurement target zone and a second column-side measurement target zone, apart from each other by a predetermined distance, on a top surface of the column are associated with the reference bar-side measurement target zone,
the measurement means measures a distance between the reference bar-side measurement target zone and the first column-side measurement target zone in each of the vertical direction, the axial direction of the spindle, and the direction perpendicular to the axial direction of the spindle on a horizontal plane and a distance between the reference bar-side measurement target zone and the second column-side measurement target zone in each of the vertical direction and the direction perpendicular to the axial direction of the spindle on the horizontal plane, and
the posture change evaluation unit evaluates a posture change of the spindle head by evaluating inclination of a linear line connecting the first column-side measurement target zone and the second column-side measurement target zone based on the measurement results of the distances by the measurement means.

7. The machine tool according to claim 6,
wherein the posture change evaluation unit stores a predetermined reference distance for each of a distance between the reference bar-side measurement target zone and the first column-side measurement target zone in each of the vertical direction, the axial direction of the spindle, and the direction perpendicular to the axial direction of the spindle on the horizontal plane and a distance between the reference bar-side measurement target zone and the second column-side measurement target zone in each of the vertical direction and the direction perpendicular to the axial direction of the spindle on the horizontal plane, and
the posture change evaluation unit evaluates a posture change of the spindle head by comparing the reference distance and the distance measured by the measurement means.

8. The machine tool according to claim 6,
wherein the measurement means measures, as a reference distance, a distance between the reference bar-side measurement target zone and the first column-side measurement target zone in each of the vertical direction, the axial direction of the spindle, and the direction perpendicular to the axial direction of the spindle on the horizontal plane and a distance between the reference bar-side measurement target zone and the second column-side measurement target zone in each of the vertical direction and the direction perpendicular to the axial direction of the spindle on the horizontal plane under a predetermined reference condition, and
the posture change evaluation unit evaluates a posture change of the spindle head by comparing the reference distance and the distance measured by the measurement means.

9. The machine tool according to claim 6,
wherein the measurement means sequentially measures a distance between the reference bar-side measurement target zone and the first column-side measurement target zone in each of the vertical direction, the axial direction of the spindle, and the direction perpendicular to the axial direction of the spindle on the horizontal plane and a distance between the reference bar-side measurement target zone and the second column-side measurement target zone in each of the vertical direction and the direction perpendicular to the axial direction of the spindle on the horizontal plane, and
the posture change evaluation unit sequentially evaluates a posture change of the spindle head by sequentially comparing the distances measured by the measurement means.

10. The machine tool according to claim 1,
wherein the reference bar has a linear expansion coefficient of 1.0×10⁻⁶/° C. or less at 30° C. to 100° C.

11. The machine tool according to claim 1,
wherein the measurement means is a displacement sensor of a contact type supported at the column-side measurement target zone.

12. The machine tool according to claim 1,
wherein the measurement means is a displacement sensor of a contactless type supported at the column-side measurement target zone.

13. The machine tool according to claim 1,
wherein the measurement means is a displacement sensor of a contact type supported at the reference bar-side measurement target zone.

14. The machine tool according to claim 1,
wherein the measurement means is a displacement sensor of a contactless type supported at the reference bar-side measurement target zone.

15. The machine tool according to claim 1,
wherein the plurality of reference bars is included.

16. The machine tool according to claim 1,
wherein a pair of columns is included, and
the reference bar is provided associated with each of the paired columns.

17. A machine tool, comprising:
a spindle head that supports a spindle for attaching a tool thereto;
a column that is disposed in a vertically standing manner, has a predetermined linear expansion coefficient in the vertical direction, and supports the spindle head; and
a reference bar that has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column, and a measurement target zone on the other end of which is possibly displaced relative to the column,
wherein in the column, a measurement target zone is associated with the measurement target zone of the reference bar, and
a measurement means measures a distance between the measurement target zone of the reference bar and the measurement target zone of the column in the vertical direction.

18. The machine tool according to claim 17, further comprising:
a posture change evaluation unit that evaluates a posture change of the column based on the measurement result of the distance in the vertical direction by the measurement means; and
a control unit that controls a position of a tip of the spindle based on the evaluation result by the posture change evaluation unit.

19. The machine tool according to claim 18,
wherein two measurement target zones apart from each other by a predetermined distance on a top surface of the column are associated with the measurement target zone of the reference bar,
the measurement means measures distances in the vertical direction between the measurement target zone of the reference bar and the two measurement target zones of the column, and
the posture change evaluation unit evaluates a posture change of the column by evaluating a change in inclination of a linear line connecting the two measurement target zones of the column based on the measurement results of the two distances in the vertical direction by the measurement means.

20. The machine tool according to claim 18,
wherein three measurement target zones apart from each other by a predetermined distance on a top surface of the column are associated with the measurement target zone of the reference bar,
the measurement means measures distances in the vertical direction between the measurement target zone of the reference bar and the three measurement target zones of the column, and
the posture change evaluation unit evaluates a posture change of the column based on the measurement results of the three distances in the vertical direction by the measurement means.

21. The machine tool according to claim 18,
wherein four measurement target zones apart from each other by a predetermined distance on a top surface of the column are associated with the measurement target zone of the reference bar,
the measurement means measures distances in the vertical direction between the measurement target zone of the reference bar and the four measurement target zones of the column, and
the posture change evaluation unit evaluates a posture change of the column based on the measurement results of the four distances in the vertical direction by the measurement means.

22. The machine tool according to claim 18,
wherein the posture change evaluation unit stores a predetermined reference distance, and
the posture change evaluation unit evaluates a posture change of the column by comparing the reference distance and the distance in the vertical direction measured by the measurement means.

23. The machine tool according to claim 18,
wherein the measurement means measures, as a reference distance, a distance in the vertical direction between the measurement target zone of the reference bar and the measurement target zone of the column under a predetermined reference condition, and
the posture change evaluation unit evaluates a posture change of the column by comparing the reference distance and the distance in the vertical direction measured by the measurement means.

24. The machine tool according to claim 18,
wherein the measurement means sequentially measures a distance in the vertical direction between the measurement target zone of the reference bar and the measurement target zone of the column, and
the posture change evaluation unit sequentially evaluates a posture change of the column by sequentially comparing the distances in the vertical direction measured by the measurement means.

25. The machine tool according to claim 17,
wherein the reference bar has a linear expansion coefficient in the vertical direction of 1.0×10⁻⁶/° C. or less at 30° C. to 100° C.

26. The machine tool according to claim 17,
wherein the column is formed with a through hole extending in the vertical direction, and
the reference bar is supported by a bearing provided to the through hole.

27. The machine tool according to claim 17,
wherein the measurement means is a displacement sensor of a contact type supported at the measurement target zone of the column.

28. The machine tool according to claim 17,
wherein the measurement means is a displacement sensor of a contactless type supported at the measurement target zone of the column.

29. The machine tool according to claim 17,
wherein the measurement means is a displacement sensor of a contact type supported at the measurement target zone of the reference bar.

30. The machine tool according to claim 17,
wherein the measurement means is a displacement sensor of a contactless type supported at the measurement target zone of the reference bar.

31. A machine tool, comprising:
a spindle head that supports a spindle for attaching a tool thereto;
a column that is disposed in a vertically standing manner, has a predetermined linear expansion coefficient in the vertical direction, and supports the spindle head; and
a first reference bar and a second reference bar, each of which has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column and a measurement target zone on the other end of which is possibly displaced relative to the column,
wherein, in the column, a first measurement target zone is associated with the measurement target zone of the first reference bar,
in the column, a second measurement target zone is associated with the measurement target zone of the second reference bar,
a first measurement means measures a distance in the vertical direction between the measurement target zone of the first reference bar and the first measurement target zone of the column, and
a second measurement means measures a distance in the vertical direction between the measurement target zone of the second reference bar and the second measurement target zone of the column.

32. A machine tool, comprising:
a spindle head that supports a spindle for attaching a tool thereto;
a column that is disposed in a vertically standing manner, has a predetermined linear expansion coefficient in the vertical direction, and supports the spindle head; and
a first reference bar, a second reference bar, and a third reference bar, each of which has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column and a measurement target zone on the other end of which is possibly displaced relative to the column,
wherein, in the column, a first measurement target zone is associated with the measurement target zone of the first reference bar,
in the column, a second measurement target zone is associated with the measurement target zone of the second reference bar,
in the column, a third measurement target zone is associated with the measurement target zone of the third reference bar,
a first measurement means measures a distance in the vertical direction between the measurement target zone of the first reference bar and the first measurement target zone of the column,
a second measurement means measures a distance in the vertical direction between the measurement target zone of the second reference bar and the second measurement target zone of the column, and
a third measurement means measures a distance in the vertical direction between the measurement target zone of the third reference bar and the third measurement target zone of the column.

33. A machine tool, comprising:
a spindle head that supports a spindle for attaching a tool thereto;
a column that is disposed in a vertically standing manner, has a predetermined linear expansion coefficient in the vertical direction, and supports the spindle head; and
a first reference bar, a second reference bar, a third reference bar, and a fourth reference bar, each of which has a predetermined height, is disposed inside the column or along a side surface of the column in a direction including at least a vertical direction component in such a manner not interfering with elongation or shrinkage of the column in the vertical direction, and has a linear expansion coefficient in the vertical direction that is different from the linear expansion coefficient in the vertical direction of the column, a fixed portion on one end of which fixed to the column and a measurement target zone on the other end of which is possibly displaced relative to the column,
wherein, in the column, a first measurement target zone is associated with the measurement target zone of the first reference bar,
in the column, a second measurement target zone is associated with the measurement target zone of the second reference bar,
in the column, a third measurement target zone is associated with the measurement target zone of the third reference bar,
in the column, a fourth measurement target zone is associated with the measurement target zone of the fourth reference bar,
a first measurement means measures a distance in the vertical direction between the measurement target zone of the first reference bar and the first measurement target zone of the column,
a second measurement means measures a distance in the vertical direction between the measurement target zone of the second reference bar and the second measurement target zone of the column,
a third measurement means measures a distance in the vertical direction between the measurement target zone of the third reference bar and the third measurement target zone of the column, and
a fourth measurement means measures a distance in the vertical direction between the measurement target zone of the fourth reference bar and the fourth measurement target zone of the column.

34. A machine tool, comprising:
a column that is disposed in a vertically standing manner and has a predetermined linear expansion coefficient;
a spindle head that is supported by the column and supports a vertical spindle for attaching a tool thereto; and
a reference bar that is disposed separately from the column and has a linear expansion coefficient that is different from the linear expansion coefficient of the column,
wherein the column has a column-side measurement target zone,
the reference bar has a reference bar-side measurement target zone, and
a measurement means measures a distance between the column-side measurement target zone and the reference bar-side measurement target zone.

35. The machine tool according to claim 34,
wherein the reference bar includes a first reference bar and a second reference bar, the first reference bar includes a first reference bar-side measurement target zone, and the second reference bar includes a second reference bar-side measurement target zone,
the column includes a first column and a second column, the first column includes a first column-side measurement target zone, and the second column includes a second column-side measurement target zone,
the measurement means includes a first measurement means and a second measurement means,
the first reference bar-side measurement target zone, the first column-side measurement target zone, and the first measurement means are associated with each other, and
the second reference bar-side measurement target zone, the second column-side measurement target zone, and the second measurement means are associated with each other.

36. The machine tool according to claim 35, further comprising:
a posture change evaluation unit that evaluates a posture change of the spindle head based on each of the measurement results of distance by the first measurement means and the second measurement means; and
a control unit that controls a position of a tip of the spindle based on the evaluation result by the posture change evaluation unit.

37. The machine tool according to claim 36,
wherein the posture change evaluation unit evaluates a posture change of the spindle head by evaluating inclination of a linear line connecting the first column-side measurement target zone and the second column-side measurement target zone based on the each of the measurement results of the distance by the first measurement means and the second measurement means.

38. The machine tool according to claim 36,
wherein the posture change evaluation unit stores predetermined reference distances between the first reference bar-side measurement target zone and the first column-side measurement target zone and between the second reference bar-side measurement target zone and the second column-side measurement target zone in each of a vertical direction and two directions perpendicular to each other on a horizontal plane, and
the posture change evaluation unit evaluates a posture change of the spindle head by comparing the reference distance and each of the distances measured by the first measurement means and the second measurement means.

39. The machine tool according to claim 36,
wherein the first measurement means measures, as a reference distance, a distance between the first reference bar-side measurement target zone and the first column-side measurement target zone in each of the vertical direction and the two directions perpendicular to each other on the horizontal plane under a predetermined reference condition and the second measurement means measures, as a reference distance, a distance between the second reference bar-side measurement target zone and the second column-side measurement target zone in each of a vertical direction and two directions perpendicular to each other on a horizontal plane under a predetermined reference condition, and
the posture change evaluation unit evaluates a posture change of the spindle head by comparing the reference distance and each of the distances measured by the first measurement means and the second measurement means.

40. The machine tool according to claim 36,
wherein the first measurement means sequentially measures a distance between the first reference bar-side measurement target zone and the first column-side measurement target zone in each of a vertical direction and two directions perpendicular to each other on a horizontal plane and the second measurement means sequentially measures a distance between the second reference bar-side measurement target zone and the second column-side measurement target zone in each of the vertical direction and the two directions perpendicular to each other on the horizontal plane, and
the posture change evaluation unit sequentially evaluates a posture change of the spindle head by sequentially comparing each of the distances measured by the first measurement means and the second measurement means.

41. The machine tool according to claim 35,
wherein the first reference bar and the second reference bar have a linear expansion coefficient of 1.0×10⁻⁶/° C. or less at 30° C. to 100° C.

42. The machine tool according to claim 35,
wherein the first measurement means and the second measurement means are displacement sensors of a contact type supported at the first column-side measurement target zone and the second column-side measurement target zone, respectively.

43. The machine tool according to claim 35,
wherein the first measurement means and the second measurement means are displacement sensors of a contactless type supported at the first column-side measurement target zone and the second column-side measurement target zone, respectively.

44. The machine tool according to claim 35,
wherein the first measurement means and the second measurement means are displacement sensors of a contact type supported at the first reference bar-side measurement target zone and the second reference bar-side measurement target zone, respectively.

45. The machine tool according to claim 35,
wherein the first measurement means and the second measurement means are displacement sensors of a contactless type supported at the first reference bar-side measurement target zone and the second reference bar-side measurement target zone, respectively.
